(19) United States
(12) Patent Application Publication
(10) Pub. No.: US 2023/0315993 A1
(43) Pub. Date: Oct. 5, 2023

(54) SYSTEMS AND PROCESSES FOR NATURAL LANGUAGE PROCESSING

(71) Applicant: Smarsh, Inc., PORTLAND, OR (US)

(72) Inventors: Thomas Nieborowski, Sebastopol, CA (US); Shravan Kumar Gond, Varanasi (IN); Ramakrishna Neeli, Bangalore (IN); George Henry, Portland, OR (US)

(21) Appl. No.: 17/697,667

(22) Filed: Mar. 17, 2022

(51) Int. Cl. G06F 16/35; G06F 16/33; G06F 40/40; G06F 40/30

(52) U.S. Cl. CPC G06F 40/30; G06F 16/3347; G06F 16/35; G06F 40/40

(57) ABSTRACT

A system for natural language processing includes a memory and at least one computing device in communication with the memory. The at least one computing device can receive a plurality of first data items and generate a cluster based on the plurality of first data items. The at least one computing device can intercept a plurality of second data items communicated between a first computing device and at least one second computing device. The at least one computing device can generate at least one vector based on the plurality of second data items and determine a similarity score between the at least one vector and the cluster. The at least one computing device can identify at least one of the plurality of second data items for review based at least in part on the similarity score.

### TECHNICAL FIELD

The present systems and processes relate generally to natural language processing.

### BACKGROUND

Natural language processing generally refers to the programming of computers to process and analyze large amounts of natural language data. Natural language data generally refers to representations of spoken or written language, such as, for example, voice recordings and electronic communications. A long-felt problem in natural language processing is the identification of semantically similar and semantically dissimilar natural language data. Previous approaches to matching subsets of natural language data typically use binary approaches that rely on exact key word and key phrase matching. However, previous solutions may be incapable of identifying similarities between subsets of natural language data that are semantically similar but do not match with 100% fidelity. For example, previous approaches may fail to recognize the similarity between phrases “send me your password” and “share the credentials,” which lack any matched terms but nonetheless have similar semantic meaning.

Therefore, there is a long-felt but unresolved need for a system or process that provides for accurate matching of natural language data.

### BRIEF SUMMARY OF THE DISCLOSURE

Briefly described, and according to one embodiment, aspects of the present disclosure generally relate to systems and processes for natural language processing.

The present system can analyze and classify natural language data and initiate one or more actions based on natural language classifications. For example, the system processes natural language data from electronic mail (e-mail) and determines that the natural language data is associated with a category of natural language corresponding to potential security risk events. In another example, the system receives a query including a key phrase. In this example, the system analyzes the natural language data of the key phrase and returns one or more items of historical natural language data that demonstrate semantic similarity to the key phrase.

The system can discover, archive, supervise, and characterize natural language and can perform additional actions based on natural language characterizations. The system can identify similarities in language regardless of whether the language elements being compared demonstrate any common terms or phrases. In other words, the system 200 analyzes and characterizes language elements based on semantic similarity (e.g., as determined in a vector space) as opposed to identifying verbatim or near-verbatim matches between terms and phrases in language elements. The system can match natural language data to historical natural language data (e.g., or a representation of the same) regardless of whether the natural language data and the historical natural language data share any exact terms or characters or share the same language. The system can receive a search input, such as a set of terms or phrases, and index historical communication data to return items that are similar to the search input (e.g., regardless of whether any of the returned items share any of the terms or phrases of the search input).

In one example, the system actively monitors communication throughout a network and determines that language in a particular email is similar to historical records of human resource policy-violating communications. In the example, the system automatically enforces a policy by performing one or more actions, such as flagging the email for review by an administrator, disabling a user account associated with the email, or storing, in a data store, the email and metadata derived therefrom (for example, sender identification, receiver identification, transmission chronology, and previous emails in the same conversation).

The system can receive and process sets of natural language data to determine if any subsets of the natural language data demonstrate similarity to a particular topic, event, or other grouping. The system can represent the particular topic or event as a cluster of vectors derived from historical natural language with which the topic or event is associated.

In an exemplary scenario, a litigation team receives a large volume of documents and must determine which documents contain evidence of potentially fraudulent behavior. The system receives the documents and extracts natural language data therefrom. The system transforms the natural language data of each document (e.g., or sections thereof) to a vector and compares each vector to one or more fraudulent behavior clusters. The system generates each fraudulent behavior cluster based on a plurality of vectors derived from historical natural language known to be associated with particular fraudulent behavior (e.g., financial fraud, mail fraud, healthcare fraud, elder fraud, etc.). The system determines that one or more vectors demonstrate a threshold-satisfying similarity to one or more fraudulent behavior clusters. The system determines the particular documents from which the cluster-matching vectors were derived and generates a report and/or updates a user interface to identify the documents, thereby allowing the litigation team to perform a manual review and confirm the match.

According to a first aspect, a natural language process, comprising: A) receiving, via at least one computing device, a plurality of first data items; B) generating, via the at least one computing device, a cluster based on the plurality of first data items; C) intercepting, via the at least one computing device, a plurality of second data items communicated between a first computing device and at least one second computing device; D) generating, via the at least one computing device, at least one vector based on the plurality of second data items; E) determining, via the at least one computing device, a similarity score between the at least one vector and the cluster; and F) in response to the similarity score meeting a predefined threshold, identifying, via the at least one computing device, at least one of the plurality of second data items for review.

According to a further aspect, the natural language process of the first aspect or any other aspect, wherein intercepting the plurality of second data items comprises intercepting communication data at a network appliance.

According to a further aspect, the natural language process of the first aspect or any other aspect, further comprising: A) retrieving, via the at least one computing device, at least one rule associated with the cluster; and B) applying, via the at least one computing device, the at least one rule to determine whether the similarity score meets the predefined threshold.

According to a further aspect, the natural language process of the first aspect or any other aspect, wherein determining the similarity score comprises determining a distance between the at least one vector and the cluster.

According to a further aspect, the natural language process of the first aspect or any other aspect, wherein the distance comprises a plurality of dimensions.

According to a further aspect, the natural language process of the first aspect or any other aspect, wherein the plurality of first data items comprises a plurality of historical communications associated with at least one rule violation.

According to a further aspect, the natural language process of the first aspect or any other aspect, wherein generating the cluster comprises: A) generating, via the at least one computing device, a plurality of vectors individually associated with the plurality of first data items; and B) defining, via the at least one computing device, a shape comprising the plurality of vectors.

According to a further aspect, the natural language process of the first aspect or any other aspect, wherein generating the cluster comprises: A) generating, via the at least one computing device, a plurality of vectors individually associated with the plurality of first data items; B) computing a centroid of the plurality of vectors; and C) defining the cluster based on a predetermined distance from the centroid.

According to a second aspect, a system, comprising: A) a memory; and B) at least one computing device in communication with the memory, the at least one computing device being configured to: 1) receive a plurality of first data items; 2) generate a cluster based on the plurality of first data items; 3) intercept a plurality of second data items communicated between a first computing device and at least one second computing device; 4) generate at least one vector based on the plurality of second data items; 5) determine a similarity score between the at least one vector and the cluster; and 6) identify at least one of the plurality of second data items for review based at least in part on the similarity score.

According to a further aspect, the system of the second aspect or any other aspect, wherein the at least one computing device is further configured to: A) generate a plurality of vectors individually corresponding to the plurality of first data items; and B) generate the cluster based on the plurality of vectors.

According to a further aspect, the system of the second aspect or any other aspect, wherein the at least one computing device is further configured to cause a user interface to be rendered on a display, the user interface comprising a cluster visualization of the cluster.

According to a further aspect, the system of the second aspect or any other aspect, wherein the at least one computing device is further configured to: A) receive an input via the user interface to adjust the size of the cluster; B) determine an updated similarity score between the at least one vector and the adjusted cluster; and C) identify at least one different one of the plurality of second data items for review based at least in part on the updated similarity score.

According to a further aspect, the system of the second aspect or any other aspect, wherein the plurality of first data items comprises a plurality of textual strings.

According to a further aspect, the system of the second aspect or any other aspect, wherein the plurality of second data items comprises data from at least one of: a text message, an email, an instant message, and a phone call sent from the first computing device to at least one second computing device.

According to a third aspect, a non-transitory computer-readable medium embodying a program that, when executed by at least one computing device, causes the at least one computing device to: A) receive a plurality of first data items; B) generate a cluster based on the plurality of first data items; C) intercept a plurality of second data items communicated between a first computing device and at least one second computing device; D) generate a plurality of vectors individually corresponding to the plurality of second data items; E) determine a plurality of similarity scores between each of the plurality of vectors and the cluster; and F) identify at least one of the plurality of second data items for review by applying at least one rule based on the plurality of similarity scores.

According to a further aspect, the non-transitory computer-readable medium of the third aspect or any other aspect, wherein the program further causes the at least one computing device to: A) determine a first language corresponding to a first one of the plurality of second data items; B) determine a second language corresponding to a second one of the plurality of second data items; C) generate a first vector corresponding to the first one of the plurality of second data items using a first algorithm corresponding to the first language; and D) generate a second vector corresponding to the second one of the plurality of second data items using a second algorithm corresponding to the second language, wherein the plurality of vectors comprise the first vector and the second vector.

According to a further aspect, the non-transitory computer-readable medium of the third aspect or any other aspect, wherein the at least one rule comprises at least one first rule when the first computing device is within a geofence when the plurality of second data items were communicated and at least one second rule differing from the at least one first rule when the first computing device is outside of the geofence when the plurality of second data items were communicated.

According to a further aspect, the non-transitory computer-readable medium of the third aspect or any other aspect, wherein the program further causes the at least one computing device to: A) receive a plurality of third data items; B) tuning the cluster based on the plurality of third data items to generate an updated cluster; C) determine an updated similarity score between the plurality of vectors and the updated cluster; and D) identify at least one different ones of the plurality of second data items for review by applying the at least one rule based on the updated similarity score.

According to a further aspect, the non-transitory computer-readable medium of the third aspect or any other aspect, wherein the program further causes the at least one computing device to: A) capture an audio file corresponding to a phone call between the first computing device and the at least one second computing device; and B) analyze the audio file using a speech to text algorithm to generate a textual string, wherein the plurality of second data items comprises the textual string.

According to a further aspect, the non-transitory computer-readable medium of the third aspect or any other aspect, wherein the program further causes the at least one computing device to identify a plurality of additional data items for review based on a similarity to the at least one of the plurality of second data items identified for review.

According to a further aspect, the non-transitory computer-readable medium of the third aspect or any other aspect, wherein the similarity comprises at least one matching metadata value.

According to a fourth aspect, a natural language process, comprising: A) receiving, via at least one computing device, a plurality of first data items; B) generating, via the at least one computing device, a cluster based on the plurality of first data items; C) retrieving, via at least one computing device, a plurality of second data items from a data archive; D) generating, via the at least one computing device, at least one vector based on the plurality of second data items; E) determining, via the at least one computing device, a similarity score between the at least one vector and the cluster; and F) in response to the similarity score meeting a predefined threshold, identifying, via the at least one computing device, at least one of the plurality of second data items for review.

According to a further aspect, the natural language process of the fourth aspect or any other aspect, further comprising normalizing the plurality of second data items across a plurality of communication modalities before generating the at least one vector.

According to a further aspect, the natural language process of the fourth aspect or any other aspect, further comprising iteratively: A) retrieving, via the at least one computing device, a plurality of additional data items from the data archive; B) generating, via the at least one computing device, a plurality of additional vectors individually corresponding to the plurality of additional data items; C) determining, via the at least one computing device, a plurality of additional similarity scores individually corresponding to a respective one of the plurality of additional vectors; and D) identifying, via the at least one computing device, whether to review any of the plurality of additional data items based on a respective similarity score of the plurality of additional similarity scores.

According to a further aspect, the natural language process of the fourth aspect or any other aspect, wherein the data archive comprises a plurality of communications between a first computing device and at least one second computing device.

According to a further aspect, the natural language process of the fourth aspect or any other aspect, further comprising: A) extracting, from the data archive, the at least one of the plurality of second data items for review; and B) generating, via the at least one computing device, a user interface rendering the at least one of the plurality of second data items for review.

According to a further aspect, the natural language process of the fourth aspect or any other aspect, further comprising generating a plurality of conversations, wherein each of the plurality of conversations comprise a respective at least two data items from the plurality of second data items.

According to a further aspect, the natural language process of the fourth aspect or any other aspect, wherein generating the at least one vector comprises generating a plurality of vectors individually corresponding to one of the plurality of conversations.

According to a fifth aspect, a system comprising: A) a memory; and B) at least one computing device in communication with the memory, the at least one computing device being configured to: 1) receive a plurality of first data items; 2) generate a cluster based on the plurality of first data items; 3) retrieve a plurality of second data items from a data archive; 4) generate a plurality of vectors individually corresponding to the plurality of second data items; 5) determine a plurality of similarity scores individually corresponding to a comparison of individual ones of the plurality of vectors and the cluster; and 6) in response to a subset of the plurality of similarity scores meeting a predefined threshold, identifying, via the at least one computing device, a corresponding subset of the plurality of second data items for review.

According to a further aspect, the system of the fifth aspect or any other aspect, wherein the at least one computing device is further configured to compute a plurality of distances individually corresponding to a respective distance between one of the plurality of vectors and the cluster, wherein the plurality of similarity scores comprises the plurality of distances.

According to a further aspect, the system of the fifth aspect or any other aspect, wherein the data archive comprises historical data of communications with at least one party being from a particular organization.

According to a further aspect, the system of the fifth aspect or any other aspect, wherein the data archive comprises historical data of communications across a plurality of communication modalities.

According to a further aspect, the system of the fifth aspect or any other aspect, wherein the data archive comprises data describing a plurality of events.

According to a further aspect, the system of the fifth aspect or any other aspect, wherein the at least one computing device is further configured to enhance the plurality of second data items before generating the plurality of vectors based on the plurality of communication modalities.

According to a sixth aspect, a non-transitory computer-readable medium embodying a program that, when executed by at least one computing device, causes the at least one computing device to: A) generate a cluster based on a plurality of first data items; B) retrieve a plurality of second data items from a data archive; C) generate a plurality of vectors individually corresponding to the plurality of second data items; D) determine a plurality of similarity scores individually corresponding to a comparison of individual ones of the plurality of vectors and the cluster; and E) in response to a first subset of the plurality of similarity scores meeting a predefined threshold, identify a second subset of the plurality of second data items for review, wherein individual ones of the second subset of the plurality of second data items correspond to a respective one of the first subset of the plurality of similarity scores.

According to a further aspect, the non-transitory computer-readable medium of the sixth aspect or any other aspect, wherein the program further causes the at least one computing device to generate the cluster by: A) generating a plurality of second vectors individually corresponding to the plurality of first data items; and B) forming the cluster from the plurality of second vectors.

According to a further aspect, the non-transitory computer-readable medium of the sixth aspect or any other aspect, wherein the program further causes the at least one computing device to generate a plurality of vectors by processing each data item of the plurality of second data items using a natural language processing algorithm for a corresponding one of the plurality of vectors.

According to a further aspect, the non-transitory computer-readable medium of the sixth aspect or any other aspect, wherein the natural language processing algorithm receives a data item input and outputs a vector.

According to a further aspect, the non-transitory computer-readable medium of the sixth aspect or any other aspect, wherein the program further causes the at least one computing device to generate a plurality of conversations, wherein each of the plurality of conversations comprise a respective at least two data items from the plurality of second data items.

According to a further aspect, the non-transitory computer-readable medium of the sixth aspect or any other aspect, wherein the respective at least two data items from at least one of the plurality of conversations comprises a first data item from a first communication modality and a second data item from a second communication modality.

According to a further aspect, the non-transitory computer-readable medium of the sixth aspect or any other aspect, wherein each of the plurality of similarity scores is based on a length of a corresponding one of the plurality of second data items.

According to a seventh aspect, a natural language process, comprising: A) receiving, via at least one computing device, a query comprising at least one first data item; B) generating, via the at least one computing device, a cluster based on the at least one first data item; C) iterating, via at least one computing device, through a plurality of second data items from a data set to: 1) generate a respective vector based on a current iteration data item of the plurality of second data items; 2) determine a current iteration similarity score between the current iteration data item and the cluster; and 3) in response to the current iteration similarity score meeting a predefined threshold, add the current iteration data item to a search result set; and D) surfacing, via the at least one computing device, the search result set responsive to the query.

According to a further aspect, the natural language process of the seventh aspect or any other aspect, further comprising: A) loading, via the at least one computing device, a plurality of predefined queries individually comprising a respective at least one third data item; and B) iterating through each of the plurality of predefined queries to: 1) generate a current query cluster based on the at least one third data item; and 2) iterating, via at least one computing device, through the plurality of second data items from the data set to: I) generate a respective vector based on a current iteration data item of the plurality of second data items; II) determine a current iteration similarity score between the current iteration data item and the current query cluster; and III) in response to the current iteration similarity score meeting a predefined threshold, add the current iteration data item to a current query search result set.

According to a further aspect, the natural language process of the seventh aspect or any other aspect, further comprising normalizing the current iteration similarity score based on a length of the current iteration data item.

According to a further aspect, the natural language process of the seventh aspect or any other aspect, further comprising: A) determining, via the at least one computing device, a particular language associated with the at least one first data item; and B) generating, via the at least one computing device, the cluster based on an algorithm corresponding to the particular language.

According to a further aspect, the natural language process of the seventh aspect or any other aspect, further comprising: A) determining, via the at least one computing device, a respective language associated with the current iteration data item; and B) generating, via the at least one computing device, the respective vector based on a respective algorithm corresponding to the respective language.

According to a further aspect, the natural language process of the seventh aspect or any other aspect, wherein determining the current iteration similarity score between the current iteration data item and the cluster comprises determining a semantic proximity of the current iteration data item to the at least one first data item in the cluster.

According to a further aspect, the natural language process of the seventh aspect or any other aspect, further comprising causing, via the at least one computing device, a user interface to be rendered on a display, the user interface comprising a subset of the search result set.

According to a further aspect, the natural language process of the seventh aspect or any other aspect, further comprising: A) receiving, via the at least one computing device, at least one input via the user interface, the at least one input indicating a classification of an data item in the search result set; B) storing, via the at least one computing device, the classification with the data item.

According to an eighth aspect, a system, comprising: A) a memory; and B) at least one computing device in communication with the memory, the at least one computing device being configured to: 1) receive a query comprising at least one first data item; 2) generate a cluster based on the at least one first data item; 3) iterate through a plurality of second data items from a data set to: I) generate a respective vector for each of the plurality of second data items; II) determine a respective similarity score between the respective vector for each of the plurality of second data items and the cluster; and III) the respective similarity score for at least one data item of the plurality of second data items meeting a predefined threshold, add the at least one data item of the plurality of second data items to a search result set.

According to a further aspect, the system of the eighth aspect or any other aspect, wherein the query is received from a data store, and the data store comprises a plurality of queries for querying the data set.

According to a further aspect, the system of the eighth aspect or any other aspect, wherein the at least one computing device is further configured to generate at least one tag for each of the at least one data item.

According to a further aspect, the system of the eighth aspect or any other aspect, wherein the at least one computing device is further configured to generate a respective classification for each of a subset of the plurality of second data items based on the respective similarity score.

According to a further aspect, the system of the eighth aspect or any other aspect, wherein the at least one computing device is further configured to surface the search result set responsive to the query.

According to a further aspect, the system of the eighth aspect or any other aspect, wherein the at least one computing device is assign the search result set to a particular group responsive to the query.

According to a ninth aspect, a non-transitory computer-readable medium embodying a program that, when executed by at least one computing device, causes the at least one computing device to: A) receive a query comprising a plurality of first data items; B) generate a cluster based on the plurality of first data items; C) iterate through a plurality of second data items from a data set to: 1) generate a respective vector based on a current iteration data item of the plurality of second data items; 2) determine a current iteration similarity score between the current iteration data item and the cluster; and 3) in response to the current iteration similarity score meeting a predefined threshold, add the current iteration data item to a search result set; and D) cause a display to render at least a subset of the search result set responsive to the query.

According to a further aspect, the non-transitory computer-readable medium of the ninth aspect or any other aspect, wherein the plurality of second data items comprise a plurality of communications and the program further causes the at least one computing device to highlight communications of interest based on the similarity scores.

According to a further aspect, the non-transitory computer-readable medium of the ninth aspect or any other aspect, wherein the program further causes the at least one computing device to assign a classification corresponding to the plurality of first data items to the plurality of second data items in the search result set.

According to a further aspect, the non-transitory computer-readable medium of the ninth aspect or any other aspect, wherein each of the plurality of first data items comprise examples of a communication from the classification.

According to a further aspect, the non-transitory computer-readable medium of the ninth aspect or any other aspect, wherein the program further causes the at least one computing device to, during each iteration, calculate a distance between the current iteration data item and the cluster using a cosine similarity calculation.

According to a further aspect, the non-transitory computer-readable medium of the ninth aspect or any other aspect, wherein the distance inversely corresponds to semantic similarity of the current iteration data item and the cluster.

According to a tenth aspect, a natural language process, comprising: A) receiving, via at least one computing device, a plurality of first data items; B) generating, via the at least one computing device, a cluster based on the plurality of first data items; C) receiving, via the at least on computing device, a plurality of second data items over time; D) generating, via the at least one computing device, a respective vector for each of the plurality of second data items; E) determining, via the at least one computing device, a respective similarity score between the respective vector for each of the plurality of second data items and the cluster; and F) in response to the respective similarity score meeting a predefined threshold for at least one of the plurality of second data items, archiving the at least one of the plurality of second data items in a data store.

According to a further aspect, the natural language process of the tenth aspect or any other aspect, wherein the plurality of second data items correspond to a plurality of events that occur over the time.

According to an eleventh aspect, a natural language process, comprising: A) receiving, via at least one computing device, a plurality of first data items; B) generating, via the at least one computing device, a cluster based on the plurality of first data items; C) receiving, via the at least on computing device, a plurality of second data items over time; D) generating, via the at least one computing device, a respective vector for each of the plurality of second data items; E) determining, via the at least one computing device, a respective similarity score between the respective vector for each of the plurality of second data items and the cluster; and F) determining, via the at least one computing device, a retention policy for each of a subset of the plurality of second data items based on the respective similarity score.

According to a further aspect, the natural language process of the eleventh aspect or any other aspect, further comprising: A) storing, via the at least one computing device, a first subset of the plurality of second data items according to a first retention policy; B) storing, via the at least one computing device, a second subset of the plurality of second data items according to a second retention policy; and C) storing, via the at least one computing device, a remaining subset of the plurality of second data items according to a default retention policy.

These and other aspects, features, and benefits of the claimed invention(s) will become apparent from the following detailed written description of the preferred embodiments and aspects taken in conjunction with the following drawings, although variations and modifications thereto may be effected without departing from the spirit and scope of the novel concepts of the disclosure.

### BRIEF DESCRIPTION OF THE FIGURES

The accompanying drawings illustrate one or more embodiments and/or aspects of the disclosure and, together with the written description, serve to explain the principles of the disclosure. Wherever possible, the same reference numbers are used throughout the drawings to refer to the same or like elements of an embodiment, and wherein:

FIG. 1 shows an exemplary natural language processing (NLP) rule diagram according to one embodiment of the present disclosure;

FIG. 2 shows an exemplary NLP system according to one embodiment of the present disclosure;

FIG. 3 shows an exemplary rule enforcement process according to one embodiment of the present disclosure;

FIG. 4 shows an exemplary natural language search process according to one embodiment of the present disclosure;

FIG. 5 shows an exemplary data visualization process according to one embodiment of the present disclosure;

FIG. 6 shows an exemplary data archive search process according to one embodiment of the present disclosure;

FIG. 7 shows an exemplary discovery process according to one embodiment of the present disclosure; and

FIG. 8 shows an exemplary archiving process according to one embodiment of the present disclosure.

### DETAILED DESCRIPTION

For the purpose of promoting an understanding of the principles of the present disclosure, reference will now be made to the embodiments illustrated in the drawings and specific language will be used to describe the same. It will, nevertheless, be understood that no limitation of the scope of the disclosure is thereby intended; any alterations and further modifications of the described or illustrated embodiments, and any further applications of the principles of the disclosure as illustrated therein are contemplated as would normally occur to one skilled in the art to which the disclosure relates. All limitations of scope should be determined in accordance with and as expressed in the claims.

Whether a term is capitalized is not considered definitive or limiting of the meaning of a term. As used in this document, a capitalized term shall have the same meaning as an uncapitalized term, unless the context of the usage specifically indicates that a more restrictive meaning for the capitalized term is intended. However, the capitalization or lack thereof within the remainder of this document is not intended to be necessarily limiting unless the context clearly indicates that such limitation is intended.

As used herein, “data item” generally refers to any data received by or acted upon by the present systems and processes. The use of the term “based on” includes “based at least in part on” and is not meant to be limiting.

### OVERVIEW

Aspects of the present disclosure generally relate to natural language systems and processes.

In various embodiments, provided herein are natural language systems and processes for performing various functions including, but not limited to, electronic discovery, supervision, and archiving. The system can evaluate (dis)similarity between natural language elements (e.g., keywords, phrases, documents, electronic communications, etc.) and, based on determinations of natural language similarity, perform various actions. The system can perform actions, such as, for example, configuring storage policies for communication data, generating and transmitting alerts, generating user interfaces for controlling natural language processes, generating visualizations of communication data and/or natural language processing outputs, and configuring settings and privileges for user accounts and computing devices.

The system can generate fixed-size representations of natural language. The system can generate natural language vectors transforming textual data into a numerical form by applying one or more embedding techniques (for example, word2vec, fasttext, Infersent, or Google universal sentence encoder). For example, the system can convert a key phrase text string to a 720-dimension vector. The system can generate groupings of vectors (referred to as “clusters”) by grouping similar vectors (e.g., vectors that are close in distance when plotted to a virtual space. For example, the system can convert a plurality of financial fraud-related communications to vector representations and generate a financial fraud cluster by determining a central point of the vector representations and defining the cluster as a sphere of predetermined diameter extending from the centroid. The system can evaluate natural language similarity by computing distance or other similarity metrics between vectors and representations derived therefrom, such as vector-derived clusters. For example, the system converts a natural language string to a 720-dimension vector and compares the vector to a cluster by computing a squared Euclidean distance between the vector and a centroid of the cluster.

The system can associate a cluster with one or more rules and can apply the one or more rules in response to matching a natural language-derived vector and the cluster. The system can apply rules by performing various actions including, but not limited to, storing natural language and related data, flagging natural language for review, adjusting privileges or other capabilities of computing devices, transmitting alerts, generating graphical user interfaces (GUIs), serving information, such as search results, to computing devices, generating or modifying clusters, and generating data visualizations.

The system can perform active supervision of and rule enforcement for communication across a network. For example, the system compares natural language from emails data to a cluster derived from historically unethical natural language data. In this example, in response to determining a match between an email and the cluster the system retrieves and applies a rule associated with the cluster by flagging the email for review by an administrator account, locking a user account associated with the email, and/or configuring a setting that causes future emails from the user account to be archived in a particular storage location.

The system can perform archiving for communication data by matching natural language thereof to one or more clusters and appending metadata to particular communication data based on cluster matches. For example, the system collects, monitors, scans, and archives all communication data from a plurality of computing devices. In this example, the system compares natural language of the communication data to a plurality of clusters derived from particular historical communication data (for example, historically unethical natural language, historically fraudulent natural language, and natural language associated with a particular event, such as a transaction or dispute). Continuing the example, the system generates metadata for each element of communication data based on the closest matching cluster and stores the communication data elements and metadata in one or more databases.

The system can perform electronic discovery by executing targeted searches of historical communication data based on natural language inputs, such as, for example, keywords, phrases, and sentences. The system can perform targeted searches by converting a natural language search input and historical communication data (e.g., emails, documents, etc.) to vectors and generating comparisons between the search input-derived vector the historical communication data-derived vectors.

The system can perform targeted searches by generating a search cluster based on a set of search inputs that are representative of the type of search results being sought. For example, the system receives, as a search input, a plurality of documents and emails containing natural language associated with a particular event. In the same example, the system converts the natural language to a plurality of vectors and generates a search input-derived cluster based on the plurality of vectors. Continuing the example, the system performs targeted searching of additional documents and emails by converting the natural language therefrom to vectors and comparing the vectors to the search input-derived cluster. In the same example, the system ranks the additional documents and emails based on the corresponding vector’s similarity to the cluster, determines one or more top-ranked documents or emails, and transmits the top-ranked documents or emails to a computing device from which the search input was received. The system can update a search cluster based on targeted search results, thereby improving search accuracy and precision. In at least one embodiment, cluster updating or other cluster optimizations may be referred to as cluster “tuning.”

### EXEMPLARY EMBODIMENTS

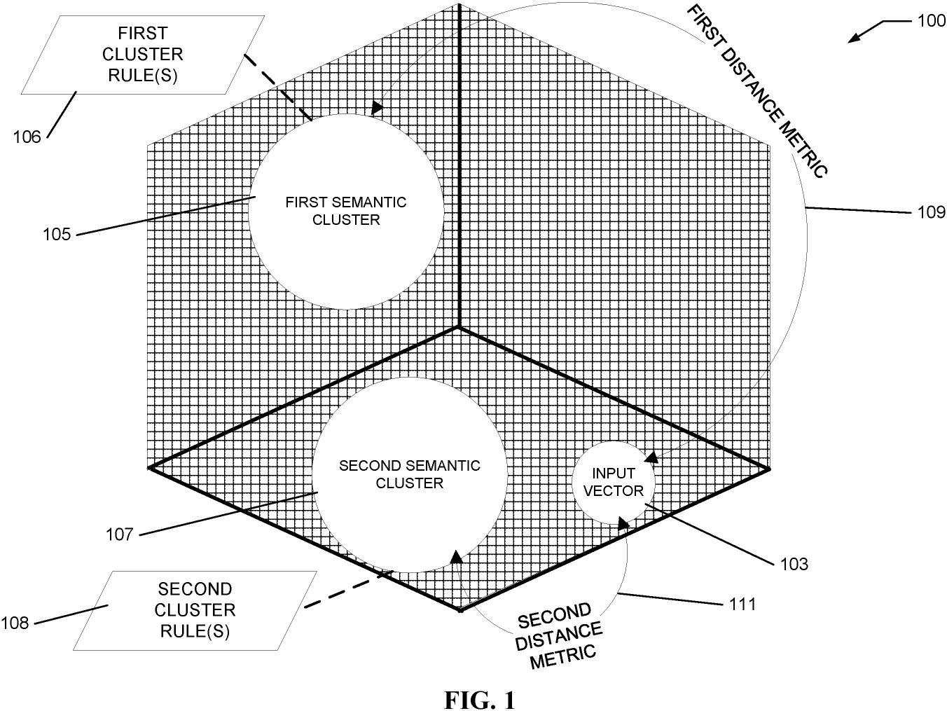

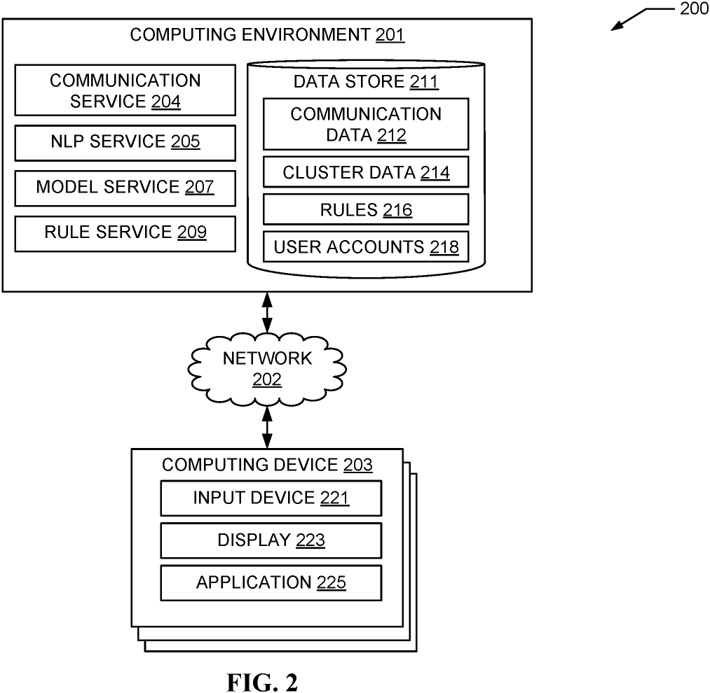

Referring now to the figures, for the purposes of example and explanation of the fundamental processes and components of the disclosed systems and processes, reference is made to FIG. 1, which shows an exemplary vector space 100. The vector space 100 of FIG. 1 provides a visualization of vector and cluster comparison processes performed by a natural language processing (NLP) system 200 (FIG. 2) according to one embodiment. In at least one embodiment, the vector space 100 illustrates how the system 200 may compare an input vector 103 to one or more clusters (e.g., for purposes of determining one or more rules that may be applied based on the input vector 103 or source thereof). For purposes of describing exemplary functions of the system 200, the following description of FIG. 1 is presented in the context of supervising emails over a network and enforcing rules related to sexual harassment and unethical behavior. Nevertheless it will be understood that no limitation of scope is intended by the following description.

The system 200 can generate the input vector 103 based on natural language from communication data transmitted by a computing device. For example, to generate the vector 103 the system 200 converts an email text string of “access to the privileged records may be provided in return for certain assurances and remittances, let’s discuss over phone” to a 720-dimension vector. The system 200 can compare the input vector 103 to semantic clusters 105, 107 and apply rules 106 or 108 based on the comparisons. As used herein, “cluster” (including the semantic clusters 105, 107) generally refers to shapes derived from two or more vectors.

The semantic cluster 105 may be a cluster derived from historical communication data associated with sexual harassment rule violations. The semantic cluster 107 may be a cluster derived from historical communication data associated with ethics rule violations. The clusters described herein may be derived from historical communication data associated with any suitable rule violation (or collection thereof), such as, for example, violations of financial disclosure rules, health disclosure rules, employment rules, health and safety rules, quality control rules, intellectual property control and communication rules, or external communication rules. The system 200 can generate clusters for identifying any suitable event, behavior, or pattern. For example, the system 200 can generate clusters for identifying illegal behavior (e.g., financial fraud, sexual harassment, violations of the Health Information Privacy Act, violations of the Family Educational Rights and Privacy Act, etc.), rule-violating behavior, discussion of a particular topic, or materiality to a particular event. The system 200 can associate the semantic cluster 105 with a rule 106 and associate the semantic cluster 107 with a rule 108. The rules 106, 108 can include actions to be performed in response to the system 200 determining a match between an input vector and the corresponding cluster 105, 107.

The system 200 can perform vector-cluster comparisons by computing distance metrics 109, 111 between the input vector 103 and each semantic cluster 105, 107. For example, to generate the distance metric 109, the system 200 computes a squared Euclidean distance between the input vector 103 and a centroid of the semantic cluster 105. The system 200 can compare the distance metric 109 and the distance metric 111 to determine a cluster association for the input vector 103. The system 200 can determine, for example, that the distance metric 111 is less than the distance metric 109 and, thus, the input vector 103 demonstrates greater similarity to the semantic cluster 107 as compared to the semantic cluster 105. In some embodiments, the system 200 compares the distance metrics 109, 111 to a predetermined similarity threshold (for example, a maximum distance value) to determine vector-cluster matching. The system 200 can determine that an input vector is associated with multiple semantic clusters, for example, if the corresponding distance metrics for each cluster both satisfy a predetermine similarity threshold. In some embodiments, the system 200 can “silence” one or more clusters for a particular user account or computing device such that matches between communication data therefrom and the one or more silenced clusters do not cause the system 200 to apply corresponding cluster rules.

The system 200 can retrieve and apply the rule 108 in response to determining a match between the input vector 103 and the semantic cluster 107. In one example, the system 200 applies rule 108 by transmitting the communication data from which the input vector 103 was derived to an administrator account. In another example, the system 200 stores the communication data at a remote server and disables a user account with which the communication data is associated. The system 200 can update the semantic cluster 107 to include the matching input vector 103. For example, the system 200 re-computes a centroid of the semantic cluster 107 based on previously used vectors and the input vector 103.

FIG. 2 shows an exemplary natural language processing (NLP) system 200. As will be understood and appreciated, the exemplary, NLP system 200 shown in FIG. 2 represents merely one approach or embodiment of the present system, and other aspects are used according to various embodiments of the present system.

The system 200 can discover, archive, supervise, and classify language and can perform various functions based on language classifications. For example, the system 200 processes text strings from a document, determines that the text strings are associated with historically financially fraudulent language, and, in response, archives the document via storage in a database. The system 200 can identify similarities in language regardless of whether the language elements being compared demonstrate any common terms or phrases. In other words, the system 200 analyzes and characterizes language elements based on semantic similarity as opposed to identifying verbatim or near-verbatim matches between terms and phrases in language elements.

In another example, the system 200 determines that language in an email is similar to historical records of rule-violating communications. In the example, the system 200 automatically enforces a rule by performing one or more actions, such as flagging the email for review by an administrator, disabling a user account associated with the email, or storing, in a data store, the email and metadata derived therefrom (e.g., sender information, receiver information, transmission chronology, and previous emails in the same conversation).

The system 200 can receive a search input, such as a set of terms or phrases, and index historical communication data to return items that are similar to the search input (e.g., regardless of whether any of the returned items share any of the terms or phrases of the search input). In one example, the system 200 receives, from a computing device, a search input including a key phrase in English. In this example, the system 200 analyzes historical communication data based on the key phrase and identifies historical documents and communications in English and German that demonstrate a high degree of semantic similarity. Continuing the example, the system 200 serves to the computing device the semantically similar documents and communications. In this example, the system 200 identifies semantically similar documents and communications without translating the English key phrase to an equivalent German phrase (e.g., the system 200 is agnostic as to a language of the input and is capable of identifying semantic similarities across multiple languages).

The NLP system 200 may include, but is not limited to, a computing environment 201 and one or more computing devices 203 that communicate over a network 202. The network 202 includes, for example, the Internet, intranets, extranets, wide area networks (WANs), local area networks (LANs), wired networks, wireless networks, or other suitable networks, etc., or any combination of two or more such networks. For example, such networks can include satellite networks, cable networks, Ethernet networks, and other types of networks.

The computing environment 201 can include a communication service 204, a natural language processing (NLP) service 205, a model service 207, a rule service 209, and a data store 211. The elements of the computing environment 201 can be provided via one or more computing devices that may be arranged, for example, in one or more server banks or computer banks or other arrangements. Such computing devices can be located in a single installation or may be distributed among many different geographical locations. For example, the computing environment 201 can include a plurality of computing devices that together may include a hosted computing resource, a grid computing resource, and/or any other distributed computing arrangement. In some cases, the computing environment 201 can correspond to an elastic computing resource where the allotted capacity of processing, network, storage, or other computing-related resources may vary over time.

The communication service 204 can receive and transmit data to and from computing devices 203, other elements of the computing environment 201, and external systems, such as, for example, software applications, remote storage environments, and cloud-based services. The communication service 204 can receive, for example, communication data 212, user inputs (e.g., from computing devices 203, user accounts, or other sources), and vector representations of natural language. The communication service 204 can retrieve natural language or other data items from the data store 211 and other data storage environments, such as, for example, data archives. A data archive can include, for example, natural language data and metadata describing a plurality of events that occur over time and/or natural language data associated with one or more communication modalities. In some embodiments, the communication service 204 can cause the computing device 203 to retrieve and share natural language or other data from a data archive or other storage environment. In one example, the communication service 204 retrieves, from a data archive, historical data of multi-party communications in which at least one party is associated with a particular entity, organization, or other criteria. The communication service 204 can intercept communications from any number of computing devices 203, user accounts 218, and other devices, systems, and accounts that transmit data over the network 202. For example, the communication service 204 connects to a network appliance (e.g., a server, network switch, a router, etc.) and intercepts any communication data transmitted thereby. In some embodiments, the network appliance can be configured to perform inspection of packets and provide particular types (e.g., messaging, email, social media, etc.) of packets to the communication service 204. In some embodiments, the communication service 204 can communicate with various services to receive or intercept data. The various services can be configured to communicate data to the communication service 204. As an example, an email service can be configured to provide the communication service 204 access to all correspondence sent over the email service. As used herein, the terms “receiving” and “intercepting” may be used to refer to intaking of data from one or more sources by the communication service 204.

The communication service 204 can perform one or more data normalization or other modification techniques to transform natural language strings into a suitable format for processing via the NLP service 205 and the model service 207. The communication service 204 can enhance natural language inputs based on metadata associated therewith. The communication service 204 can generate or retrieve one or more text strings based on metadata corresponding to a natural language input and update the natural language input to include the metadata-derived text strings. For example, the communication service 204 intercepts emails from an Apple IPhone™, retrieves natural language from the email conversations, and enhances the natural language by adding text strings for a sender address, receiver address, timestamp, and location. The communication service 204 can identify and correct (e.g., or flag for correction) misspellings and other typos in natural language data items. The communication service 204 can receive or determine classifications or tags with which a natural language item is associated and store the natural language data item in association with the classification or tag. The model service 207 may utilize classifications and/or tags as an additional variable from which similarity scores are determined.

The communication service 204 can capture audio files and apply one or more speech-to-text algorithms or techniques to generate textual string corresponding to natural language recorded in the audio files. In some embodiments, the communication service 204 determines whether an audio file contains multiple speakers, determines a voice signature corresponding to each of the speakers, and generates metadata for the audio file (e.g., or text generated therefrom) that identifies subsets of the audio file that correspond to each speaker. In one example, the communication service 204 captures an audio file corresponding to a phone call between the first computing device and a second computing device. In this example, communication service 204 analyzes the audio file using a speech to text algorithm to generate a textual string corresponding to natural language recorded in the audio file.

The communication service 204 can generate communications, such as, for example, alerts, emails, push notifications, text messages, computer voice messages, reports, and data visualizations. In one example, the communication service 204 generates a report including communication data 212, identifications of one or more clusters to which the communication data 212 was matched, and a confidence metric corresponding to the cluster match (for example, a distance metric or a comparison between the distance metric and a predetermined matching threshold). The communication service 204 can flag, highlight, or otherwise identify natural language inputs and subsets thereof for further review by a user. For example, the model service 207 determines that a subset of natural language from a data archive is similar to a natural language from a search query received via a user’s computing device 203. In this example, the communication service 204 causes the computing device 203 to render the subset of natural language on the display 223. In a similar example, the communication service 204 causes the computing device 203 to render the natural language from the data archive and render a highlight visual over the subset of the natural language that was matched to the search query.

In another example, in response to the system 200 matching communication data 212 to a financial fraud cluster, the communication service 204 generates and transmits an email notification to an administrator account. In another example, the communication service 204 generates a cluster mapping visualization based on distance comparisons between communication data 212 and a plurality of clusters. In this example, for each cluster the cluster mapping visualization can include a cluster identifier or title and exemplary historical communication data 212 from which the cluster was generated.

The communication service 204 can configure and enforce various policies, such as, for example, data storage policies, data access policies, and data retention policies. For example, the model service 207 matches communication data 212 to a financial fraud cluster and, in response, the communication service 204 adjusts a retention policy for the communication data 212 such that the data is retained for a greater time period (e.g., 3 years, 5 years, 10 years, or another suitable interval). In another example, the communication service 204 adjusts a data access policy for a particular user account such that the particular user account is blocked from accessing company servers or databases. The communication service 204 can generate or retrieve metadata corresponding to communication data 212 and communications generated by the communication service 204. Non-limiting examples of metadata include timestamps, geolocation information, network traffic information, device information (e.g., IP address, serial number, MAC address, firmware version, etc.), content type, communication duration, and access records (e.g., login, logout, and setting change events). In one example, in response to receiving communication data 212 from a computing device 203, the communication service 204 generates and stores metadata including a timestamp of one or more communications, IP address of the computing device 203, and contact information of the recipient.

In some embodiments, a rule 216 is associated with one or more metadata criteria such that the rule 216 (e.g., or a subset thereof, such as particular action) may only be applied when a) a vector or other natural language representation is matched to the cluster (or other data representation) with which the rule 216 is associated and b) the one or more metadata criteria are determined to be satisfied. The communication service 204 can receive user selections for applying metadata criteria and configure vector matching and rule enforcement processes based thereon. Non-limiting examples of metadata criteria include geozone, communication type, communication source type (e.g., mobile device, laptop computer, tablet), network utilized (e.g., external public networks, personal home networks, cellular networks, internal company networks, etc.), and timestamp. The communication service 204 can determine or identify metadata corresponding to received and intercepted communication data and the rules service 209 can determine whether one or more metadata criteria are met by applying a corresponding rule 216. For example, the rules service 209 applies a first rule 216 in response to determining that a natural language input was intercepted from a computing device 203 while the computing device 203 was located inside of a predetermined geozone. In the same example, the rules service 209 applies a second rule 216 (e.g., instead of the first rule 216) in response to determining that the natural language input was intercepted from the computing device 203 while the computing device 203 was located outside of a predetermined geofence.

The NLP service 205 generates fixed-size representations of communication data. For example, the NLP service 205 transforms a sentence to a first 720-dimension vector and translates a word to a second 720-dimension vector. The NLP service 205 can transform communication data into vectors of any length, such as, for example, 720 dimensions, 360 dimensions, 1440 dimensions, or any suitable value. The NLP service 205 can be agnostic as to an alphabet, character set, language, or lexicon with which communication data is associated. For example, the NLP service 205 receives communication data including emails in English and emails in Arabic, each set of emails including semantically similar phrases. Continuing the example, the NLP service 205 generates a first vector based on the set of English emails and a second vector based on the set of Arabic emails. In this example, when plotted in a three-dimensional space, the first vector and the second vector are close in distance (e.g., despite the non-matched languages of the email sets associated with each vector).

In some embodiments, the NLP service 205 is a library or service that the computing environment 201 may call to transform communication data 212 into vectors. For example, the computing environment 201 transmits communication data to the NLP service 205 via an application programming interface (API). In this example, the NLP service 205 transforms the communication data into one or more vectors and transmits the one or more vectors to the computing environment 201.

The NLP service 205 can use language-specific algorithms and techniques to generate vector representations of natural language. The NLP service 205 and/or the communication service 204 can determine a language with which a natural language string is associated. The NLP service 205 can identify and implement a vectorization algorithm or other technique based on the determined language of the natural language input. For example, the NLP service 205 determines that a first natural language string is associated with German language and that a second natural language string is associated with French language. In the same example, the NLP service 205 applies a German language-associated algorithm to generate a vector representation of the first natural language string and applies a French language-associated algorithm to generate a vector representation of the second natural language string.

The model service 207 performs various analyses and apply various transformations to vectors generated by the NLP service 205. The model service 207 can generate clusters based on the vectors, each cluster representing a set of semantically similar vectors. The model service 207 can generate a cluster by applying one or more algorithms, machine learning models, or other techniques to a plurality of vectors and/or one or more initial clusters derived therefrom. The model service 207 can cluster a plurality of vectors in a divisive technique by defining an initial cluster that includes the plurality of vectors and dividing the initial cluster into secondary clusters. The model service 207 can divide the initial cluster, for example, by determining a subset of the plurality of vectors that are most dissimilar to (e.g., most distant from) the remaining plurality of vectors and defining the secondary cluster based on the subset of the plurality of vectors. The model service 207 can continue dividing the initial cluster (and/or one or more secondary clusters) by iteratively determining subsets of the initial cluster that are most dissimilar and generating secondary clusters based on the subsets. The model service 207 can continue the divisive technique until a predetermined number of clusters are generated or until the model service 207 determines that all vectors of the initial cluster (and/or one or more secondary clusters) demonstrate a level of similarity that satisfies a predetermined threshold.

The model service 207 can cluster a plurality of vectors in a hierarchical technique (also referred to as an “agglomerative” technique) by defining each vector as a cluster and by combining nearest clusters into a larger, secondary cluster. The model service 207 can combine clusters by computing and comparing centroids of each cluster. The model service 207 can combine clusters with centroids that are determined to be within a predetermined distance of another centroid (e.g., proximate clusters are merged while distant cluster neighbors are excluded).

The model service 207 can perform comparisons between vectors, between vectors and clusters, and between clusters. For example, the model service 207 can compare a vector to one or more clusters to determine if the vector demonstrates threshold-satisfying similarity or distance to a cluster. The model service 207 can perform a comparison by computing a distance metric or similarity metric between the vector and each cluster (e.g., in particular, the centroid of each cluster). The distance metric or similarity metric can include, but is not limited to, Euclidean distance, squared Euclidean distance, Hamming distance, Minkowski distance, L² norm metric, cosine metric, Jaccard distance, edit distance, Mahalanobis distance, vector quantization (VQ), Gaussian mixture model (GMM), hidden Markov model (HMM), Kullback-Leibler divergence, mutual information and entropy score, Pearson correlation distance, Spearman correlation distance, or Kendall correlation distance. The distance metric can refer to measurements performed in two, three, four, or any suitable number of dimensions. For example, the model service 207 computes a squared Euclidean distance between the vector and a centroid of a cluster. In another example, the model service 207 determines a boundary of a cluster and computes an L² norm between the vector and a boundary of the cluster. In some embodiments, the model service 207 normalizes a similarity score based on a length of the natural language data item with which the similarity score is associated. For example, the model service 207 upwardly or downwardly scales a similarity score in proportion to natural language string length.

In some embodiments, the model service 207 generates similarity scores based at least in part on metadata values demonstrated by the communication data 212 (e.g., or other natural language being modeled) as compared to metadata criteria with which one or more clusters (or other natural language representations) are associated. In one example, a cluster is associated with a particular geozone and a particular device type (e.g., mobile device, personal device, work device, etc.). In this example, the model service 207 increases a similarity score for a natural language vector in response to determining that the communication data 212 (e.g., from which the natural language vector as derived) was received from a computing device 203 of the particular device type and while the computing device 203 was located inside of a predetermined geozone.

The model service 207 can tune a cluster by adjusting one or more cluster properties, such as, for example, a boundary of the cluster, vectors from which the cluster is derived, a classification of natural language from which the cluster is derived, or a source of natural language from which the cluster is derived. In one example, the model service 207 tunes a cluster by generating an updated cluster based on the original set of vectors from which the cluster was derived and one or more additional vectors derived from additional natural language. In another example, the model service 207 tunes a cluster by generating an updated cluster based on a subset of the original set of vectors from which the cluster was derived. In this example, the rules service 209 determines the subset by applying one or more rules 216 to the original set of vectors, such as, for example, a rule that removes vectors with metadata that fails to satisfy predetermined metadata criteria. In a particular example, the model service 207 tunes a cluster by regenerating the cluster such that only vectors associated with a particular type of computing device, time interval, and/or location are leveraged to generate the updated cluster. In various embodiments, following cluster tuning, the model service 207 generates updated similarity scores by comparing natural language vectors to the updated cluster.

The rule service 209 can generate, control, and apply rules and rules. The rules and polices can be based on rules 216 stored in the data store 211. The rule service 209 can generate and determine associations between rules 216 and clusters described herein (e.g., clusters that may be defined by cluster data 214). The rule service 209 can apply rules 216 in response to determinations from the model service 207. For example, based on a distance computation the model service 207 determines that a vector is associated with a particular cluster. In this example, in response to the determination the rule service 209 retrieves and applies one or more rules 216 associated with the particular cluster. In another example, the model service 207 generates a cluster based on a plurality of vectors and stores the cluster in cluster data 214. In the same example, the communication service 204 receives user input that selects a particular rule with which to associate the cluster. Continuing the example, based on the user input the rule service 209 generates or retrieves a corresponding rule 216 and updates the cluster data 214 of the cluster to associate the rule 216 with the cluster. The rule service 209 can receive or generate a rule and associate the rule with one or more clusters, for example, by updating rules 216 and/or cluster data 214.

The rule service 209 can apply a rule by initiating one or more actions including, but not limited to, flagging communication data 212 for review, suspending services or limiting other functions of the computing device 203, storing communication data 212, generating or updating cluster data 214, commanding the model service 207 to generate comparisons, determinations and/or data visualizations, commanding the NLP service 205 to generate vector representations of communication data 212, and commanding the communication service 204 to generate and transmit information. For example, the rule service 209 determines that particular communication data 212 from a computing device 203 is associated with a financial fraud cluster and retrieves rules 216 associated therewith. In the same example, the rule service 209 applies the rules 216 by flagging the particular communication data 212 for review by an administrator, transmitting an alert to a computing device with which an administrator is associated, and suspending access of the computing device 203 and/or a user profile associated therewith to one or more financial systems.

In one example, the rule service 209 flags communication data 212 by updating metadata of the communication data 212. In another example, the rule service 209 flags communication data 212 flags by generating and transmitting an alert to a computing device or other system associated with an administrator. Alerts can refer to any electronic communication, such as, for example, text messages, emails, push notifications, phone calls, and electronic reports. In one example, the rule service 209 flags communication data 212 and commands the model service 207 to generate a new cluster based on the communication data 212 and a cluster with which the communication data 212 was determined to be associated.

In another example, the rule service 209 changes a privilege level of a computing device 203 such that the computing device 203 is unable to access particular systems, services or files and/or is unable to communicate with other computing devices 203. In another example, the rule service 209 changes a security level of a computing device 203 such that the computing device 203 requires additional security steps, such as two factor authentication, biometric verification, increased password complexity requirements, or more frequent password reset. In another example, the rule service 209 changes a security level of a computing device 203 such that the computing device 203 may only access services or perform other functions when particular criteria are determined to be met, such as operation within a particular time period (e.g., 9:00AM-5:00PM, 2 hours a day, or another suitable period) or within a particular location (e.g., a business location, a predetermined home address, a client site, etc.).

The rules service 209 can apply one or more rules 216 for modifying or filtering natural language data to be acted upon by the NLP service 205 or model service 207. For example, the rules service 209 can apply a rule 216 that removes particular keywords from natural language input (e.g., thereby redacting the information and preventing the keywords from affecting subsequent analyses). In another example, the rules service 208 applies a rule 216 for filtering natural language data items based on one or more metadata criteria, such as, for example, location from which natural language data was generated, received, or transmitted, time interval during which natural language data was generated, or device type from which natural language data was generated.

The data store 211 can store various data that is accessible to the various elements of the computing environment 201. In some embodiments, data (or a subset of data) stored in the data store 211 is accessible to the computing device 203 and one or more external systems (e.g., on a secured and/or permissioned basis). Data stored at the data store 211 can include, but is not limited to, communication data 212, cluster data 214, rules 216, and user accounts 218. The data store 211 can be representative of a plurality of data stores 211 as can be appreciated.

The communication data 212 can include any natural language data generated at or transmitted by the computing device 203 or any natural language data transmitted over the network 202 (e.g., or over other networks with which the computing device 203 communicates). Natural language data generally refers to spoken, written, or typed language. The communication data 212 can include, for example, emails, text messages, application inputs, geolocation data, biometric data (e.g., facial image, fingerprint, voice signature, etc.), phone records, entry records (for example, digital logins, badge swipe-in events, and other credential use records), documents, spreadsheets, images, presentations, voice records, voice transcripts. The communication data 212 can include communication metadata, such as, for example, network flow data that describe when communications were sent, to which destinations communications were sent, and from which sources communications were sent.

The cluster data 214 refers to data that defines a cluster (e.g., a three-dimensional vector space). The cluster data 214 can include sets of vector coordinates that each define a cluster. The cluster data 214 can include coordinates derived from sets of vector coordinates, such as, for example, coordinates of a centroid. The cluster data 214 can include distance thresholds used in various actions described herein. The cluster data 214 can include, for example, a minimum cluster distance threshold used by the model service 207 to determine whether an input vector should be associated with a particular cluster based on a distance between the vector and a centroid of the particular cluster.

The cluster data 214 can include clusters associated with particular types of behaviors or events, such as, for example, fraudulent activities, unethical activities, and illegal behaviors. In one example, the cluster data 214 includes a cluster derived from a plurality of vectors, the plurality of vectors being derived from emails and documents associated with insider trading. In another example, the cluster data 214 includes a cluster derived from phone records, text message, and other communications associated with financial fraud. In another example, the cluster data 214 includes a cluster derived from phone records, text message, and other communications associated with financial fraud. The model service 207 can generate new cluster data 214 that defines additional clusters. For example, the model service 207 determines that a vector is associated with a particular cluster. In the same example, the model service 207 generates new cluster data 214 including the vector and a new cluster generated by the model service 207 based on the particular cluster and the vector.

The rules 216 can include policies, protocols, and commands that are executed in response to various determinations of the rule service 209. The rules 216 can cause the system 200 (e.g., or particular elements thereof) to perform one or more actions. Non-limiting examples of rules 216 include data collection rules, data storage rules, user account rules, cluster rules,

Non-limiting examples of data collection rules 216 include increasing or decreasing a frequency of data collection from one or more devices or systems, increasing or decreasing a depth of collected data (e.g., collecting greater or fewer data types and/or data points), and discovering additional devices or services associated with a user account 218 and initiating data collection therefrom. In one example, applying a rule 216 for increasing depth or specificity of collected data causes the communication service 204 to collect, from a computing device 203 or other system, additional historical data (e.g., data backdated from 6 weeks, 6 months, 2 years, or another suitable interval).

In another example, applying a rule 216 for increasing collected data depth causes the communication service 204 to collect information for one or more additional types of data associated with communications, such as geolocation data, timestamp data, or transmission data (e.g., sender-receiver information, whether a communication was transmitted automatically or manually, whether a communication was viewed, stored, or forwarded, etc.).

Non-limiting examples of data storage rules 216 include archiving data at a particular storage location (for example, a remote server) and/or for a particular time period (e.g., 2 weeks, 2 months, 2 years, etc.), adjusting a retention policy for particular data (for example, data associated with a particular user account 218 or computing device 203), and adjusting access to stored data for one or more user accounts 218 or computing devices 203. In one example, applying a rule 216 for adjusting data archiving causes the communication service 204 to store communication data 212 of a particular user account 218 or computing device 203 at a remote storage environment, such as a remote server or a cloud-based storage environment. In another example applying a rule 216 for adjusting deletion rule causes the data store 211 to increase a storage time of data from a first interval (e.g., 1 week, 1 month, 1 years, etc.) to a second interval (e.g., 2 weeks, 3 months, 3 years, indefinitely, etc.).

Non-limiting examples of user account rules 216 include disabling user account access to particular services, systems, networks, or computing devices 203, adjusting password, credential, and/or security rules, transmitting communications to a user account or device associated therewith, and transmitting data associated with one or more user accounts. In one example, applying a rule 216 for disabling a user account causes the computing environment 201 to suspend access to a user account 218 for a predetermined time period (e.g., 2 weeks, 3 months, 1 year, indefinitely, or another suitable interval). In another example, applying a rule 216 for disabling a user account causes the computing environment 201 to adjust a privilege level of a user account 218 such that the user account 218 is prevented from accessing (e.g., or accessing with editing or administrative privileges) particular contacts, particular computing devices 203, financial systems, sensitive storage environments, supply chain management services, business-related servers or computing environments, other user accounts 218, and/or other suitable systems and services. In another example, applying a rule 216 for adjusting security rule causes the user account 218 or computing device 203 associated therewith to enforce a two-factor authentication process for controlling account access, enforce additional password requirements (e.g., additional criteria, more frequent password reset, etc.), and/or cause a password reset. In another example, applying a rule 216 for communicating with a user account 218 causes the communication service 204 to transmit particular information to a user account 218 (e.g.., or computing device 203). In this example, the particular information can include communication data 212 that was matched to a particular cluster and a description of the matched cluster (e.g., “financial fraud,” “possible phishing attempt,” “unethical behavior,” “illegal behavior,” etc.).

Non-limiting examples of cluster rules 216 include updating cluster data 214 based on one or more (mis)matching vectors or other communication data 212, segmenting a cluster into two or more clusters, and adjusting similarity thresholds for determining cluster (mis)matches. In one example, applying a rule 216 for updating cluster data 214 causes the model service 207 to generate a new cluster based on a previous cluster and a communication data-derived vector that was matched to the previous cluster. In another example, applying a rule 216 for segmenting a cluster causes the model service 207 to divide a primary cluster into two secondary clusters (e.g., or any suitable number) by grouping the vectors of the primary clusters into two groups (e.g., based on similarity metrics and one or more clustering thresholds). In this example, the model service 207 compares a primary cluster-matched vector to the secondary clusters and, thereby, matches and characterizes the vector at an increased level of specificity.

In another example, applying a rule 216 for adjusting a similarity threshold causes the model service 207 to increase or decrease the similarity threshold. In some embodiments, the rule service 209 applies a rule 216 for adjusting similarity thresholds based on length of communication data 212 from which a vector-to-be-matched was derived. The rule service 209 can increase the similarity threshold with increasing character length of the communication data 212. For example, the rule service 209 configures a greater similarity threshold for a multi-word phrase or sentence input as compared to a similarity threshold configured for a single word input.

The user accounts 218 can include data associated with one or more user accounts. The user accounts 218 can refer to user accounts that interact with the system 200, any user account from which the communication service 204 receives communication data 212, or any user account defined or described in communication data 212. For example, user accounts 218 includes credentials (e.g., usernames, passwords, public-private key pairs, device identifiers, contact information, etc.) for identifying, authenticating, and tracking interactions of users with the computing environment 201 and computing devices 203 (e.g., or otherwise tracking user behavior across the network 202). In another example, user accounts 218 includes credentials for authenticating communications between the computing environment 201 and one or more external systems.

The user account 218 can include various settings for controlling functions and privileges of the user account. The user account 218 can include, but is not limited to, access privileges (e.g., for granting and preventing access of the user account 218 to particular systems, services, computing devices 203, or the network 202), security policies for accessing the user account 218 (e.g., password and credential rules, multi-factor authentication policies, etc.), settings for controlling transmission of communication data 212 to the communication service 204, and settings for controlling clustering and cluster-matching processes of the model service 207. Settings for controlling communication data 212 transmission or collection include, for example, frequency settings (e.g., virtually instant, hourly, daily, or weekly transmission or collection of communication data 212), local retention of communication data 212 on a computing device 203 associated with the user account 218, and remote retention of communication data 212 via transmission from a computing device 203 to a remote storage environment.

The computing device 203 can be any network-capable device including, but not limited to, servers, smartphones, laptop or desktop computers, tablets, smart accessories (for example, smart watches, key fobs, etc.), vehicle control systems, and multimedia control systems. The computing device 203 can be associated with a particular user account 218. The association can be based on an identifier of the computing device 203, such as, for example, a serial number, phone number, or networking address (for example, a MAC address). In some embodiments, the communication service 204 associates the computing device 203 with a user account 218 in response to determining that a user has accessed the user account 218 via the computing device 203 or in response to receiving a user account-associated transmission from the user account 218. The computing device can include an application 225 for accessing various functions of the system 200 and/or for enabling collection of communication data 212 from the computing device 203.

The computing device 203 can include a processor and memory. The computing device 203 can include a display 223 on which various user interfaces can be rendered by an application 225 to configure, monitor, and control various functions of the system 200. The application 225 can correspond to a web browser and a web page, a mobile app, a native application, a service, or other software that can be executed on the computing device 203. The application 225 can display information associated with processes of the system 200 and/or data stored thereby. The application 225 can transmit user inputs and communication data 212 to the communication service 204. For example, the application 225 can collect emails, text messages, network activity and other communication-related information from the computing device 203 and transmit the data to the communication service 204. In another example, the application 225 receives user input for initiating cluster creation, data supervision, data archiving, and/or data discovery processes described herein and transmits the user input to the communication service 204 (e.g., in the form of a command that causes the computing environment 201 to initiate one or more corresponding actions).

The computing device 203 can include an input device 221 for providing inputs, such as requests and commands, to the computing device 203. The input devices 221 can include a keyboard, mouse, pointer, touch screen, speaker for voice commands, camera or light sensing device to reach motions or gestures, or other input devices. The application 225 can process the inputs and transmit commands, requests, or responses to the computing environment 201. According to some embodiments, functionality of the application 225 is determined based on a particular user account 218 or other privilege level with which the computing device 203 is associated. In one example, a first computing device 203 is associated with an administrator user account and the application 225 is configured to permit access and viewing of communication data 212 from user accounts 218 and transmit commands to the computing environment 201 for controlling functions and processes thereof. In this example, a second computing device 203 is associated with an employee user account, and the application 225 is configured to allow the computing device 203 to transmit communication data 212 to the computing environment 201 and to receive commands from the computing environment 201 (e.g., commands for controlling data storage, password and credential policies, etc.).

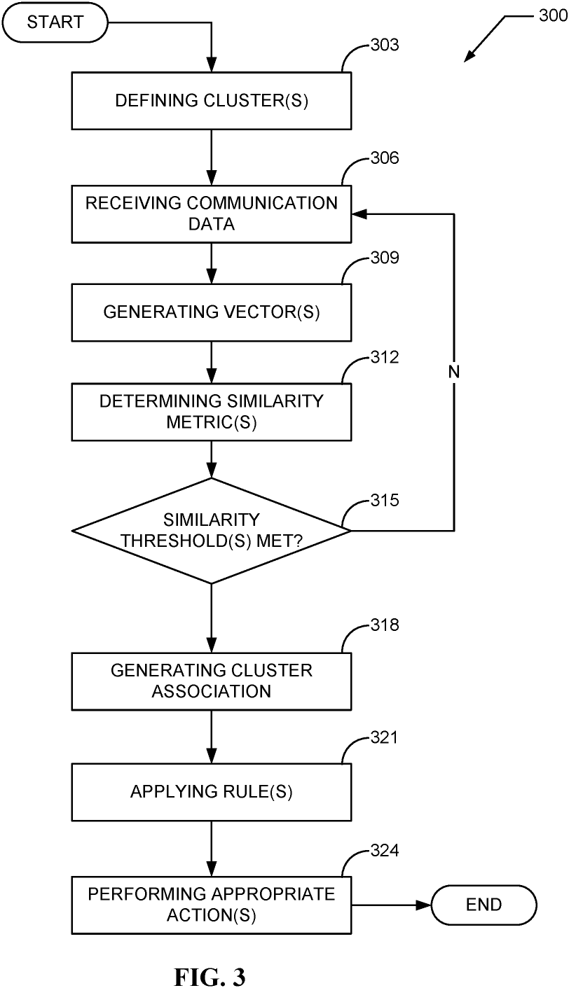

FIG. 3 shows an exemplary rule enforcement process 300. As will be understood by one having ordinary skill in the art, the steps and processes shown in FIG. 3 (and those of all other flowcharts and sequence diagrams shown and described herein) may operate concurrently and continuously, are generally asynchronous and independent, and are not necessarily performed in the order shown. The system 200 can perform the process 300 to supervise, detect, and archive communication data 212 of particular type or quality. The process 300 can be performed continuously or at a predetermined interval (e.g., hourly, daily, weekly, etc.) to supervise and record communication data 212 flowing throughout the network 202 and enforce various rules 216 based on (mis)matches between the communication data 212 and one or more clusters. In one example, the system 200 performs the process 300 on behalf of a corporate messaging service to detect, archive, and respond to communications that violate company policies (e.g., ethics policies, sexual harassment policies, legality policies, morality policies, fraud policies, etc.).

At step 303, the process 300 includes defining one or more clusters. The model service 207 can define a cluster based on cluster data 214 including, for example, a plurality of vectors derived from communication data 212. The plurality of vectors can be associated with a particular event, activity, classification, pattern, sender/receiver, and/or data type (e.g., an event, activity, classification, pattern, etc., that a user desires to detect in additional communication data). Generating the cluster can include plotting the plurality of vectors and defining a shape that includes the plurality of vectors (e.g., or a minimum subset thereof). Generating the cluster can include computing a centroid of the plurality of vectors and defining the cluster based on a predetermined distance from the centroid.

The application 225 and/or the communication service 204 can cause the computing device 203 to render a cluster visualization to a user and allow the user to adjust a size of the cluster (e.g., based on selection of a predetermined size, manipulation of a slider, manual input of a cluster size, etc.). The cluster visualization can include an example of communication data 212 that may be matched to the current iteration of the cluster. For example, during generation of a cluster for detecting unethical behaviors in emails, the model service 207 and the communication service 204 generate a cluster visualization including exemplary historical emails that would and would not be matched to the cluster based on a current size of the cluster. In response to receiving a command to reduce a cluster size, the model service 207 can reduce a boundary of the cluster such that a subset of the plurality of vectors are excluded from inclusion. In response to receiving a command to increase cluster size, the model service 207 can increase a boundary of the cluster such that additional vectors are included. In some embodiments, the communication service 204 receives a selection of non-cluster-matched historical communication data 212 from a cluster visualization and causes the model service 207 to adjust the cluster such that vectors derived from the selected historical communication data 212 are included. In at least one embodiment, the communication service 204 receives a selection of cluster-matched historical communication data 212 from a cluster visualization and causes the model service 207 to adjust the cluster such that vector derived from the selected historical communication data 212 are excluded.

At step 306, the process 300 includes receiving communication data 212. The communication data 212 received at step 306 refers to communication data to be (mis)matched to one or more clusters. The communication service 204 can receive (e.g., or intercept) communication data 212 from one or more computing devices 203 and collect data from one or more systems or services connected to the network 202. In one example, the communication service 204 receives a plurality of document files and email conversations. In another example, the communication service 204 receives a plurality of text message conversations, phone call logs, and transcriptions of phone calls. In another example, the communication service 204 iteratively retrieves, via a computing device 203, a plurality of natural language data items from a data archive.

In some embodiments, the communication service 204 receives an audio file (for example, a phone recording) and the NLP service 205 generates a transcription and a vector representation of the audio file. The communication service 204 can store the communication data 212 in the data store 211. The communication service 204 can receive and/or generate metadata corresponding to the communication data 212, such as, for example, a timestamp of the original transmission or creation thereof, sender-receiver information (e.g., sender/receiver identifiers, associations with user accounts 218, etc.), and geolocation data.

The application 225 can receive user input including communication data 212. In one example, the application 225 generates or accesses a user interface for receiving natural language inputs and a user pastes a selection of natural language into the user interface. In the same example, the application 225 transmits the natural language to the communication service 204 for transformation to a vector and comparison to the one or more clusters (e.g., clusters generated at step 303 or other clusters stored in cluster data 214).

In at least one embodiment, the communication service 204 receives user input that indicates a classification of a natural language data item. For example, the communication service 204 receives a user input classifying a natural language data item as “financial fraud,” “personal attack,” “sexual harassment,” or “privileged information exposure.” The communication service 204 can store classifications at the data store 211 in association with the corresponding natural language data item. The model service 207 can leverage natural language classifications and/or tags when generating clusters and/or determining similarity between clusters and vectors. In one or more embodiments, the communication service 204 generates or retrieves metadata corresponding to natural language inputs, such as, for example, sender location, receive location, timestamp, and communication modality. In some embodiments, the communication service 204 generates and applies one or more tags to natural language data items. The tags can define characteristics of the natural language (e.g., language, length, type) and indicate metadata with which the natural language is (or is not) associated. For example, the tag indicates that particular natural language was not received from a business-affiliated computing device 203 or that the particular natural language was received via an organization-affiliated local network.

At step 309, the process 300 includes generating one or more vectors based on the communication data. The NLP service 205 can transform the communication data 212 into one or more vectors. For example, the NLP service 205 transforms an email into a 720-dimension vector. In another example, the NLP service 205 generates a transcription of a voice recording and transforming the transcription into a vector.

At step 312, the process 300 includes determining one or more similarity metrics between the vector and one or more clusters. The model service 207 can determine similarity by computing a similarity metric (for example, a squared Euclidean distance) between the vector of step 309 and one or more clusters, such as the cluster generated at step 306 or other clusters retrieved from cluster data 214. The model service 207 can compute a similarity metric between the vector and a centroid of the cluster or a predetermined cluster boundary. For example, if the cluster is visualized as a virtual sphere, the model service 207 can determine the similarity metric based on a center point of the virtual sphere or a point on the outer surface of the virtual sphere. The model service 207 can store the similarity metric, for example, as cluster data 214 or as metadata associated with the communication data 212 from which the vector was derived. In some embodiments, the similarity metric can be adjusted based on search parameters. As an example, the model service 207 can generate a search score based on search parameters such as matching metadata, matching character strings, and timing data among other aspects. The model service 207 can further calculate the similarity metric based on a weighting of the search score.

At step 315, the process 300 includes determining whether the similarity metric satisfies one or more similarity thresholds (e.g., magnitudes of distance, probability, or another value of similarity). In response to determining that the similarity metric satisfies the similarity threshold, the process 300 can proceed to step 318. In response to determining that the similarity metric fails to satisfy the predetermined threshold, the process 300 can return to step 306 (e.g., thereby continuing the active supervision of communications). The model service 207 can retrieve the similarity threshold from cluster data 214. In some embodiments, the model service 207 generates or adjusts a similarity threshold based on a length of the communication data 212 from which the vector was generated. For example, a vector derived from a single word may be associated with a smaller similarity threshold as compared to a similarity threshold for a vector derived from a multi-word phrase, sentence, or longer language segment. The model service 207 can match the vector to multiple clusters, for example, in an instance where similarity thresholds for multiple clusters are satisfied. In some embodiments, the model service 207 matches the vector to a cluster demonstrating the smallest similarity metric (e.g., the cluster with which the vector is most closely matched).

At step 318, the process 300 includes applying one or more rules based on the one or more clusters to which the vector was determined to match. The rule service 209 can retrieve one or more rules 216 associated with the one or more clusters to which the vector was matched. The rule service 209 and/or other elements of the system 200 can apply the one or more rules 216 by performing various actions. The computing environment 201 can, for example, modify data retention policies for the communication data 212, adjust security and/or access settings for a user account 218 and/or computing device 203 associated with the communication data 212, generate and transmit a communication to one or more user accounts 218 or computing devices 203, generate a visualization of the vector-cluster comparison, generate user interfaces, or modify cluster data 214.

The communication service 204 can generate, and transmit to a computing device 203, a communication (e.g., a text message, email, push notification, voice message, graphic, etc.) including one or more of communication data 212 from which the vector was derived, an identification of the cluster to which the vector was matched, a description of the cluster, exemplary historical communication data 212 associated with the cluster, and an identification of one or more rules 216 associated with the cluster. The application 225 can cause the computing device 203 to render a user interface including the transmitted information and selectable fields for receiving input to initiate one or more actions. In one example, the model service 207 matches a vector to an “official client communication” cluster and the rule service 209 applies a rule 216 that causes the communication service 204 to modify a data retention policy of the associated communication data 212 for archiving (e.g., long-term storage, such as a period of 2 years, 3 years, 10 years, etc.). In another example, the model service 207 matches a vector to an “internal office communication” cluster and the rule service 209 applies a rule 216 that causes the communication service 204 to modify a data retention policy of the associated communication data 212 for automated deletion scheduling (e.g., deletion after a short period, such as 1 week, 1 month, 3 months, etc.).

In another example, the model service 207 generates a cluster based on a plurality of vectors derived from a formal complaint and pleadings associated with a litigation suit and the rule service 209 associates a rule 216 with the “litigation” cluster such that any communication data 212 that demonstrates a cluster-matching vector is reported to a user account 218 and stored in a particular location. In the same example, the NLP service 205 transforms each of a plurality of discovery documents to vectors and the model service 207 matches one of the vectors to the litigation cluster. Continuing the example, the rule service 209 applies the rule 216 by causing the communication service 204 to transmit an alert to a user account 218 and/or computing device 203 and store the corresponding discovery document in a particular folder and/or server.

The system 200 can apply multiple rules 216. In one example, the model service 207 matches an email-derived vector to a cluster associated with unethical behavior. In this example, the rule service 209 retrieves and applies a first rule 216 for permanent storage of the email in a remote storage environment, a second rule 216 for transmitting an alert to an administrator user account 218, and a third rule 216 for updating the matched cluster based on the vector. Continuing the example, in response to the rules, the communication service 204 stores the email at a remote server and transmits an alert to the administrator user account 218 (e.g., the alert including the email, the similarity metric, and an identification of the email’s source) and the model service 207 updates the cluster by computing a new centroid of the cluster based on previous vectors associated therewith and the newly matched vector.

At step 321, the process 300 includes performing one or more appropriate actions. The one or more actions can include, for example, tuning the matched cluster to include the matched vector, modifying security and/or access policies for a user account 218 or computing device 203, generating a visualization of the vector-cluster comparison, analyzing additional historical communication data 212, or adjusting properties of the vector-cluster comparison (e.g., increasing or decreasing similarity thresholds, initiating comparisons to other clusters, generating and transmitting a ranking of cluster similarity metrics, etc.). In one example, the model service 207 tunes the cluster by generating an updated cluster based on the vectors from which the current cluster was derived and the one or more vectors that were matched to the cluster at step 315. In another example, the model service 207 tunes the cluster by generating an updated cluster based on the current cluster source vectors and a second set of vectors derived from additional natural language inputs.

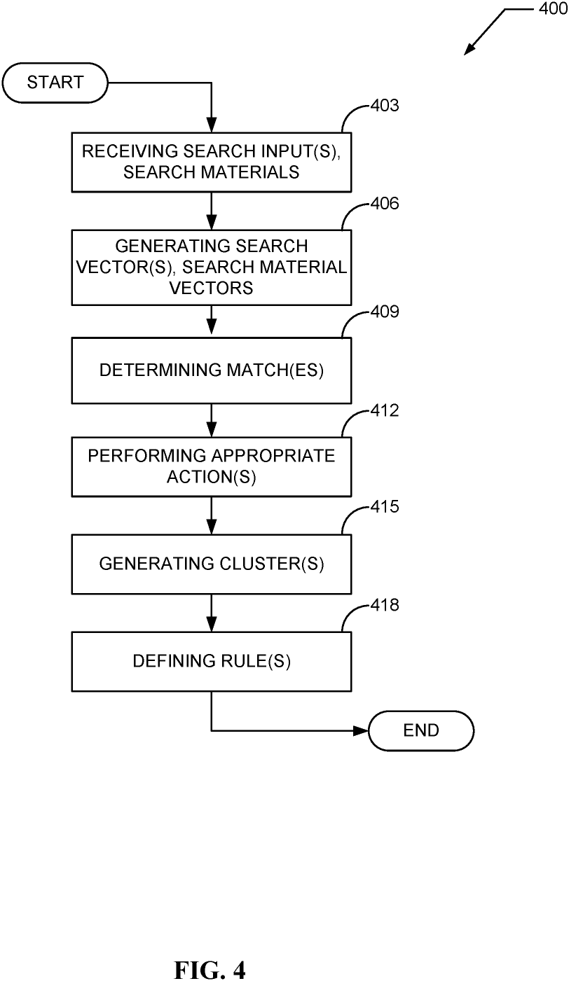

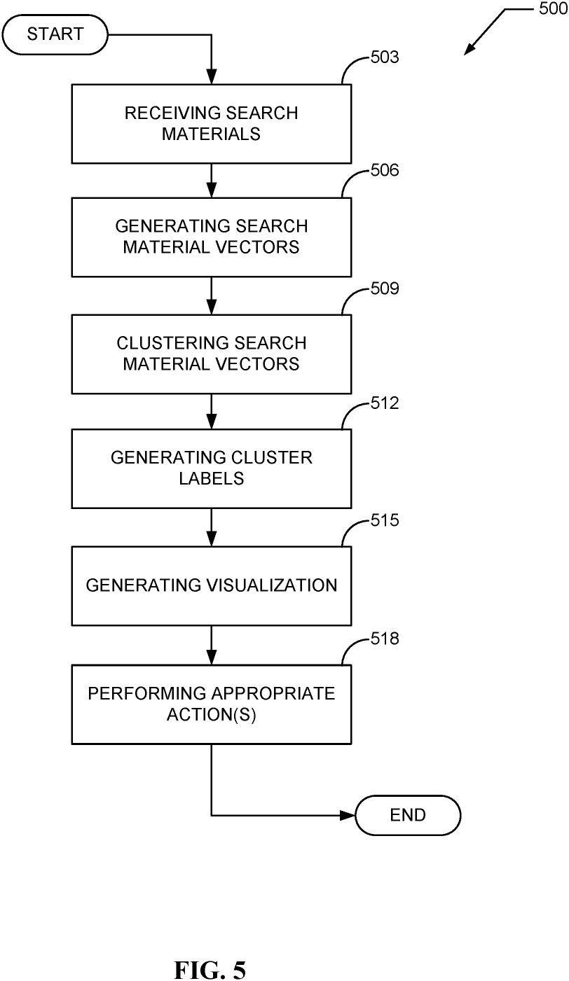

In another example, based on a rule 216, the system 200 automatically archives communication data 212 from the user account 218 and/or computing device 203 associated with the cluster-matching vector. In another example, the system 200 initiates the process 400 (FIG. 4) to analyze historical communication data 212 from the vector-associated user account 218 or computing device 203 and determine if similar communications from the same user account 218 or computing device 203 exist. In another example, the system 200 initiates the process 500 (FIG. 5) to generate a visualization of the cluster-matching vector and the one or more clusters to which the vector was compared. In this example, the visualization can include exemplary historical communication data 212 corresponding to vectors that define each cluster (e.g., exemplary unethical emails may be displayed for an unethical behavior cluster, exemplary financially fraudulent documentation may be displayed for a financial fraud cluster, etc.).

FIG. 4 shows an exemplary natural language search process 400. The system 200 can perform the process 400 to process search materials and identify a subset of the search materials that demonstrate threshold-satisfying similarity to a search input. The system 200 can perform the process 400 as an interactive search in which the system 200 generates a vector based on an input of search strings and/or historical communication data 212 and attempts to match additional historical communication data 212. The system 200 can render outputs of the process 400 on one or more computing devices 203 (for example, a computing device 203 from which a search query was received). In one example, rendering the output of the process 400 (or other processes described herein) includes updating a listing of natural language inputs such that cluster-matching natural language inputs are provided to the top of the listing and, thereby, presented directly to a user.

At step 403, the process 400 includes receiving one or more search inputs and search materials. The communication service 204 can receive search inputs and search materials from the computing device 203 or user account 218 and/or or via retrieval of communication data 212 from the data store 211. In some embodiments, the communication service 204 receives search inputs and/or other search selections in the form of a search query. The search inputs can include any number and any length of text strings, such as, for example, key phrases, sentences, and/or paragraphs that describe or represent subject matter a user wishes to identify in the search materials. In some embodiments, the search inputs include search settings and parameters for controlling the process 400. Non-limiting examples of search settings and parameters include search output format (e.g., a report, ranked list, interactive user interface, data visualization, etc.), time ranges, search targets (e.g., a particular user account, database, document, etc.), search sensitivity (e.g., which may increase or decrease similarity thresholds), and result limit (e.g., restricting reported search results to a number of top-ranked matches). In one example, the communication service 204 receives an input to reduce a size of a cluster and determine similarity scores for a plurality of vectors based on the adjusted cluster. In this example, the model service 207 reduces a boundary of the cluster such that one or more vectors are excluded from computation of the cluster centroid (e.g., thereby reducing the size of the cluster). Continuing the example, the model service 207 generates an adjusted cluster based on the reduced boundary and determines updated similarity scores between each of the plurality of vectors and the adjusted cluster. In another example, the communication service 204 receives an input to increase a size of a cluster, and, in response, the model service 207 extends a boundary of a cluster such that one or more additional vectors that were previously excluded from computation of the cluster centroid are included in the computation of a new cluster centroid. The model service 207 can increase or decrease cluster size by any suitable method or technique.

The search materials can be any data object that includes text data (e.g., text strings) or data from which text data may be extracted (e.g., scanned documents, photos, and other data objects from which text may be extracted via optical character recognition or another suitable method). In some embodiments, the communication service 204 (e.g., or a system, service, or application in communication therewith) performs optical character recognition and text extraction on the search materials to generate natural language strings for subsequent vectorization and comparison. The search materials can include communication data 212, such as, for example, electronic mail, transcriptions of phone calls, memos, and text message conversations. In one example, the communication service 204 receives, as search material, a set of discovery documents related to pending litigation. In the same example, the communication service 204 receives, as a first search input, “Company A,” “Company B,” “Account No. 20475,” “debt transfer,” and “special purpose entity.” Continuing the example, as a second search input, the communication service 204 receives aa search range parameter for “December 14^{th}, 2020 - April 11^{th}, 2021,” thereby causing the process 400 to consider only those search materials associated with or generated between December 14^{th}, 2020 and April 11^{th}, 2021 (e.g., which the system may determine based on search material metadata, such as timestamps associated with each discovery document).

At step 406, the process 400 includes generating a search vector and a plurality of search materials vectors based on the search input and search materials of step 403, respectively. In some embodiments, when a plurality of natural language search inputs are received, the NLP service 205 individually transforms each search input to a search vector and the model service 207 clusters the search vectors into a search cluster. The NLP service 205 generates a plurality of search material vectors based on subsets of the search material, such as, for example, individual document pages or page ranges, individual paragraphs, or individual sentences. In at least one embodiment, the model service 207 performs clustering on the plurality of search material vectors to generate two or more search material clusters for subsequent comparison to the search vector (e.g., or search cluster). For example, the model service 207 performs clustering on a plurality of discovery document-derived search material vectors and generates, as output, a first cluster related to financial subject matter, a second cluster related to legal subject matter, and a third cluster related to employment and staffing subject matter. According to one embodiment, the clustering of search material vectors prior to matching may provide for more computationally efficient comparison processes.

At step 409, the process includes determining one or more matches by comparing the search vector or search cluster to the plurality of search material vectors or search material clusters. The model service 207 can perform the comparisons in a manner similar to step 312 of the process 300. The model service 207 can output a plurality of similarity scores based on the comparisons. The model service 207 can generate a ranked list of search material vectors based on the plurality of similarity scores. In some embodiments, the model service 207 limits the ranked list only to those search material vectors (e.g. or clusters) demonstrating a similarity score that satisfies a predetermined similarity threshold (e.g., the ranked list may be limited only to threshold-confirmed matches). The model service 207 can determine that a number of threshold-confirmed matches exceeds a predetermined match limit (e.g., thereby indicating that the search sensitivity may be too high) or fails to meet a predetermined match minimum (e.g., thereby indicating that the search sensitivity may be too low). The model service 207 can adjust the similarity threshold such that a number of threshold-confirmed matches falls within a predetermined match limit or at least meets a predetermined match minimum.

At step 412, the process includes performing one or more appropriate actions. The communication service 204 can generate a report that identifiers natural language (e.g., or selectable pointers that redirect a user to the natural language) for which a corresponding search material vector was matched to the search input vector. The communication service 204 can generate a data visualization, such as, for example, a point map that illustrates the determined similarity of the search materials (e.g., or subsets thereof) to the search input. In at least one embodiment, the system performs the data visualization process 500 (FIG. 5) to generate the visualization.

The communication service 204 can generate and cause the computing device 203 to render a user interface for reviewing results of the process 400, adjusting parameters of the process 400 (for example, search input, similarity thresholds, time ranges, search materials, search material vectorization, etc.), and initiating additional actions. The additional actions, can include, but are not limited to, generating a cluster based on the matched search materials, generating a rule 216 with which the search material-derived cluster will be associated, storing the search materials as communication data 212, and transmitting results of the process 400 to one or more user accounts 218 or computing devices 203.

Based on output of the process 400, the communication service 204 or the computing device 203 can perform database deduplication to identify and eliminate duplicate copies of particular data from one or more databases.

In an exemplary scenario, the system 200 performs the process 400 on a search input including a particular document and search materials including plurality of documents from a particular database. The NLP service 205 generates a virtual “fingerprint” of the particular document by transforming the search input to a search input vector. The NLP service 205 transforms each of the plurality of documents from the particular database into a search material vector. The model service 207 compares each search material vector to the search input vector and determines one or more matches. The communication service 204 generates and transmits a report to a computing device 203, the report identifying a subset of the documents with which the one or more matches are associated. The computing device 203 performs database deduplication by deleting copies of the subset of documents from the particular database. In various embodiments, the vector-based processes performed by system 200 provide significant computational efficiency advantages as compared to current and previous deduplication processes that rely on keyword matching and other traditional techniques for grouping natural language.

In some embodiments, following step 412, the system 200 suspends the process 400. In at least one embodiment, the system 200 performs steps 415-418 of the process 400 to generate one or more clusters based on the search material vectors and associate one or more rules 216 therewith. For example, in steps 403-412 the system 200 determines that a subset of search material vectors match a search input for financial fraud. In the same example, the system 200 performs steps 409-412 to generate a cluster based on the subset of search material vectors and associate the cluster with a rule 216 for an elevated retention policy including long-term storage at a remote computing environment. In this example, the system 200 uses the new cluster to perform the process 300 and, thereby, monitor for communication data 212 that may be associated with financial fraud.

At step 415, the process 400 includes generating one or more clusters based on a plurality of search material vectors. The model service 207 can generate the cluster similar to step 318 of the process 300. The model service 207 can store the new cluster as cluster data 214.

At step 418, the process 400 includes defining one or more rules 216 with which the one or more clusters of step 415 are associated. The communication service 204 can generate and serve, to the computing device 203 or user account 218, a user interface for selecting one or more predetermined rules 216 or for selecting options and settings by which the rules service 209 generates the rule 216. For example, the user interface includes predetermined rules 216 for increasing storage retention, suspending account privileges, and transmitting alerts to particular user or administrative accounts. In another example, the user interface includes selectable options for configuring retention policies (e.g., storage length, location, access permission, etc.), communication policies (e.g., communication format, communication destination, etc.), and/or security policies (e.g., user account privileges, credential and login requirements, etc.). The communication service 204 can receive selections for one or more predetermined rules 216 and, in response, cause the rules service 209 to associate the corresponding cluster data 214 with the selected rule 216. The communication service 204 can receive selections for one or more parameters, settings, or options, and, in response, cause the rules service 216 to generate a new rule 216 based thereon and associate the new rule 216 with the corresponding cluster data 214.

In an exemplary scenario of the process 400 the communication service 204 receives, from a computing device 203, a query including at least one first data item (for example, a set of historical natural language strings associated with a particular event or topic). The communication service 204 assigns a classification to each of the plurality of first data items. Each of the plurality of first data items can include exemplary natural language strings from a historical communication associated with the classification. The model service 207 generates a cluster based on the at least one first data item and the classification. The communication service 204 receives a plurality of second data items (for example, a set of natural language strings from an email conversation history). In an iterative manner, the NLP service 205 transforms a respective current iteration data item of the plurality of second data items into a vector and, based on the vector, the model service 207 determines a current iteration similarity score between the current iteration data item and the cluster. In response to determining the current iteration similarity score meets a predetermined threshold, the communication service 204 adds the current iteration data item to a search result set. Throughout or following the iterative similarity analysis the communication service 204 causes the computing device 203 to update a display 223 such that the search result set is surfaced and, thereby, presented to a user.

In a similar exemplary scenario, in addition to comparing the second data items and the at least one first data-derived cluster, the communication service 204 loads a plurality of a plurality of predefined queries individually comprising a respective at least one third data item. In an iterative manner for each of the plurality of predefined queries model service 207 generates a current query cluster based on the at least one third data item. In a further iterative manner for each of the plurality of second data items, the NLP service 205 generates a respective vector based on a current iteration data item of the plurality of second data items and the model service 207 determines a current iteration similarity score between the current iteration data item the current query cluster. In response to determining the current iteration similarity score satisfies a predetermined threshold, the communication service 204 adds the current iteration data item to a current query search result set.

FIG. 5 shows an exemplary data visualization process 500. The system 200 can perform the process 500 to generate visualizations of vector-cluster comparisons that allow for visual observation of (dis)similarities within communication data 212 (represented by vectors) and between the communication data 212 and various topics (represented by clusters). The system 200 can perform the process 500 to identify and present patterns or groupings in communication data 212, for example, by performing clustering techniques on a plurality of vectors derived from the communication data 212.

At step 503, the process 500 includes receiving search data including, but not limited to, communication data 212 and search commands for configuring the process 500. The communication service 204 can receive communication data 212 from a user account 218 or computing device 203 or by retrieving the communication data 212 from the data store 211. In one example, the communication service 204 receives text documents. In another example, the communication service 204 receives a plurality of email conversation records.

The communication service 204 can receive search commands, such as, for example, commands for selecting particular data visualization types, data visualization settings, or data reporting settings. The communication service 204 can configure data visualization generation and command other elements of the computing environment 201 in response to the commands. For example, in response to a particular command, the communication service 204 causes the model service 207 to perform clustering on a plurality of vectors derived from a set of documents. Non-limiting examples of data visualization types include vector maps, cluster maps, word clouds, two- or three-dimensional bubble charts, tree maps, circle packing charts, heat maps, radar charts, radial bar charts, radial column charts, scatter plots, stacked area graphs, and stream graphs. For example, the communication service 204 receives a command to perform clustering on vectors derived from the communication data 212 and generate a two-dimensional bubble chart to visualize a plurality of clusters derived from the vectors. In another example, the communication service 204 receives a command to compare email-derived vectors to historical clusters associated with various topics (e.g., harassment, unethical behavior, financial malfeasance, etc.). In the same example, the command instructs the communication service 204 to generate a radar chart for each vector to, thereby, visualize each email’s degree of association to each of the various topics.

Non-limiting examples of data visualization settings include historical communication data 212 or clusters to which the received communication data 212 may be compared, clustering and other grouping thresholds, chart element labels, and axis ranges. In one example, the communication service 204 receives a command to perform clustering and data visualization at a high level of sensitivity and, in response, the communication service 204 causes the model service 207 to use lower cluster grouping thresholds (e.g., thereby requiring a higher degree of similarity for association with a particular cluster).

Non-limiting examples of data reporting settings include data visualization output format (e.g., digital document, electronic mail, electronic image, spreadsheet, or other suitable file), output destination (e.g., particular computing devices 203, user accounts 218, network addresses at which an output may be hosted, and external systems to which data visualizations may be transmitted), and output security (e.g., credential or other login requirements or restrictions). In one example, a command instructs the communication service 204 to output a data visualization as a high-resolution electronic image, host the image at a particular network address, and transmit a link for the particular network address to a particular computing device 203. In another example, in response to a command, the communication service 204 generates a digital data visualization image file and a spreadsheet file (e.g., CSV file, Excel file, etc.) that includes similarity metrics, grouping thresholds, and other cluster comparison data from which the data visualization was generated.

At step 506, the process 500 includes generating one or more vectors based on the communication data 212 data received (or retrieved) at step 503. The NLP service 205 can transform the communication data 212 into one or more vectors similar to step 309 of the process 300 or steps 406-409 of the process 400. In some embodiments, the communication service 204 receives selections of particular natural language to be transformed into a vector. For example, the communication service 204 receives communication data 212 and a user’s selection for a subset of the communication data 212. In this example, the communication service 204 extracts the natural language of the selected subset and causes the NLP service 205 to transform the natural language into a vector.

At step 509, the process 500 includes clustering the vectors generated at step 506. In some embodiments, clustering refers to performing a one-to-many comparison between each of a plurality of vectors and grouping subsets of the plurality of vectors into groups based on the comparisons and one or more grouping thresholds. In at least one embodiment, clustering refers to performing a one-to-many comparison between each of a plurality of vectors and one or more predetermined clusters and associating subsets of the plurality of vectors with the one or more predetermined clusters.

In an exemplary scenario, the NLP service 205 transforms each of a plurality of emails into vectors. The model service 207 determines a similarity value between each vector. The model service 207 determines one or more subsets of the vectors that are close in similarity (e.g., close in distance) by comparing the corresponding similarity values to a cluster grouping threshold. The model service 207 generates a cluster based on each of the one or more subsets.

In some embodiments, the model service 207 applies a minimum cluster size such that, to group vectors into a cluster, the number of vectors to-be-grouped must be equal to or greater than the minimum cluster size (e.g., 2, 5, 10, 15, or any suitable number of vectors). The model service 207 can automatically increase a cluster grouping threshold in response to determining that a subset of similar vectors fails to satisfy a minimum cluster size. In one or more embodiments, the model service 207 applies a maximum cluster size such that, to group vectors into a cluster, the number of vectors to-be-grouped must be less than or equal to the maximum cluster size (e.g., 50, 100, 1000, or any suitable number of vectors). The model service 207 can automatically decrease a cluster grouping threshold in response to determining that a subset of similar vectors fails to satisfy a maximum cluster size.

At step 512, the process 500 includes defining a cluster label for the cluster generated at step 509. In some embodiments, the process 500 omits step 512 and proceeds from step 509 to step 515.

The model service 207 can define a cluster label via one or more techniques, such as, for example, latent semantic analysis, latent Dirichlet allocation, and other topic modeling techniques and algorithms. For example, the model service 207 retrieves natural language with which a step 509-defined cluster is associated and performs local topic modeling to identify a natural language string that describes, defines, and/or represents the subject matter of the cluster. The model service 207 can define a cluster label by matching the cluster to a predetermined cluster with which a particular topic is associated (e.g., the predetermined cluster being originally derived from historical communication data 212 associated with the particular topic). For example, the model service 207 computes a centroid of the cluster generated at step 509 and compares the centroid to centroids of a finance-related cluster, a sexual harassment-related cluster, and a protected speech-related cluster. In the example, the model service 207 determines that the determined centroid is closest to a centroid of the protected speech-related cluster and that the distance between the centroids is less than or equal to a maximum distance threshold. Continuing the example, the communication service 204 generates and associates the cluster of step 509 with a “protected speech” label.

At step 515, the process 500 includes generating a data visualization. The model service 207 can generate multiple data visualizations of varying type and/or settings. The communication service 204 can cause the model service 207 to generate a particular chart, graph, or other model based on commands received at step 503 or preferences with which a particular user account 218 or computing device 203 is associated. The model service 207 can generate the data visualization by performing appropriate plotting and scaling operations with which the particular data visualization is associated. For example, the model service 207 generates a bubble chart or scatter plot by plotting the centroids of each cluster generated at step 509. Continuing the example, the model service 207 plots a circumference around each plotted centroid, the circumference being based on a most-distant vector with which the centroid is associated. In another example, the model service 207 generates a radar chart by configuring each of a plurality of predetermined clusters as axial variables, plotting a shape at the center of the radar chart, and stretching the shape along each of the axes based on the similarity between the vector or cluster and the predetermined cluster with which the axis is associated.

At step 518, the process 500 includes performing one or more appropriate actions. The communication service 204 can transmit the data visualization to a computing device 203, user account 218, or other external systems. For example, the communication service 204 generates a web page at a particular network address, hosts the data visualization at the particular web page, and transmits a link to the particular network address to the computing device 203 from which the system 200 received communication data 212 at step 503. The communication service 204 can transmit the data visualization (e.g., and other data associated therewith, such as the corresponding natural language or similarity metrics upon which the data visualization was based) to the application 222. The application 222 can generate and cause the computing device 203 to render a user interface including the data visualization. The communication service 204 can store the data visualization at the data store 211 or another environment, such as, for example, an external cloud storage service. The communication service 204 can receive additional commands for adjusting the data visualization, such as, for example, adjustments to grouping thresholds, maximum or minimum cluster sizes, or cluster labels. The communication service 204 can update (e.g., or cause the model service 207 to update) the data visualization based on one or more commands.

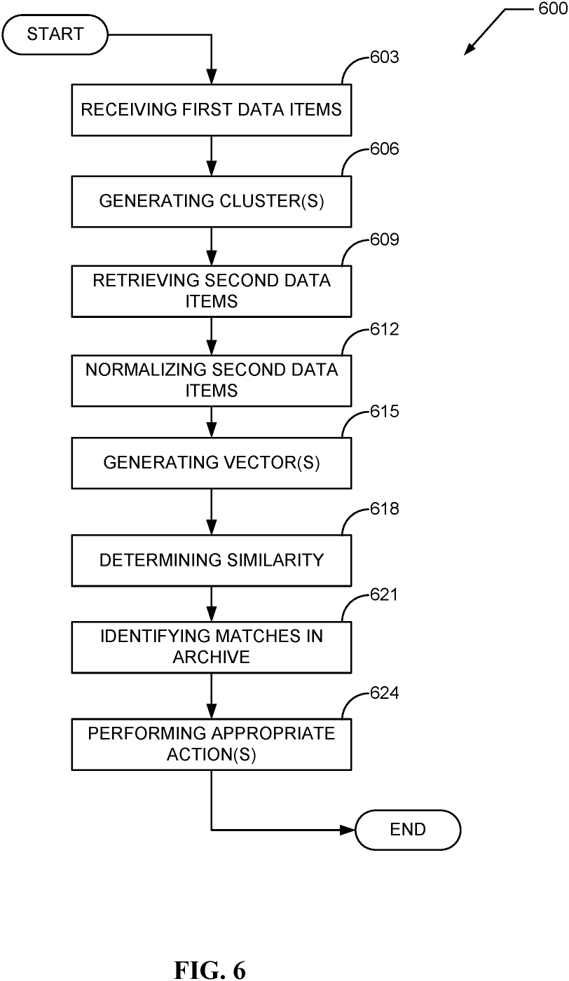

FIGS. 6-9, in particular, refer to processes performed on “data items.” As used herein, “data item” can refer to communication data 212 or any other natural language strings, or collections thereof. In some embodiments, the term data item is inclusive of any metadata with which a data item (e.g., or a device and/or user that generated the same) may be associated.

FIG. 6 shows an exemplary data archive search process 600 according to one embodiment of the present disclosure. In some embodiments, the process 600 can be used to search for documents, communications, data items, or other data in an archive, data store, or document corpus.

At step 603, the process 600 includes receiving a plurality of first data items. For example, the communication service 204 can receive one or more search phrases, paragraphs, documents, text summaries, or other data to search against a data archive. The communication service 204 can receive exemplary email conversations that are known to be associated with a particular topic, event, or other criteria, such as, for example, a rule violation. The communication service 204 can receive data illustrating a pattern associated with a rule violation, such as, for example, a series or pattern of phone calls, emails, financial transactions, and/or financial reporting windows across one or more users that was connected to an insider trading conviction.

At step 606, the process 600 includes generating a cluster based on the plurality of first data items. Step 606 can be performed similar to step 303 of the process 300 (FIG. 3), step 415 of the process 400 (FIG. 4), or steps 506-509 of the process 500 (FIG. 5). The NLP service 205 and the model service 207 can generate the cluster by transforming each of the plurality of first data items into a vector and defining the cluster based on at least a subset of the plurality of vectors. The cluster can represent a search query in a vector space that can be compared against other vectors to surface search results.

In other words, by steps 603-606, the system 200 parametrizes data archive searching by transforming the desired search criteria (e.g., as represented by the first plurality of data items) into a cluster to which search item-derived vectors may be compared.

At step 609, the process 600 includes retrieving a plurality of second data items from an archive (e.g., hosted at the data store 211, a computing device 203, or any other environment accessible to the communication service 204). For example, the communication service 204 retrieves a plurality of email conversations from a data archive hosted at a remote server, the plurality of email conversations being associated with a particular time interval, location, event, topic, or other criteria. The communication service 204 can receive email, text messages, documents, and other data by reading the data from a data archive. The communication service 204 can search through a document corpus or set of files in one or more data archives. In some embodiments, the communication service 204 can receive a data stream from an archiving service to perform a search on the stream data items.

At step 612, the process 600 includes normalizing the second plurality of data items. In particular embodiments, the process 600 omits step 612. In some embodiments, the data is normalized prior to being stored in a data store or data archive. The computing environment 201 can normalize each of the plurality of second data items across a plurality of communication modalities. The communication service 204 can extract metadata from each of the plurality of second data items. The communication service 204 can analyze the metadata to identify particular values, such as names, addresses, other contact information, timing information (e.g., when a message was sent), and other data. The communication service 204 can normalize the metadata to fit within particular data fields across communication modalities. As an example, the communication service 204 can reformat a sent data stamp to fit a predefined data format across various emails, instant messages, phone calls, and SMS messages. The communication service 204 can analyze phone call audio files to generate a textual version of each phone call. The communication service 204 can convert the textual information for each data item to a vector and compare distances between the vectors to generate metadata describing relationships between the data items. As an example, the communication service 204 can identify that a first set of data items all relate to a common topic, and associate a topic identifier or topic phrase with each of the data items to expedite future searching.

The communication service 204 can analyze the data items to group data items between sets of participants, which can be grouped based on a time window. As an example, the communication service 204 can determine that a phone call, an email, and a series of instant messages were exchanged during a particular day between two users and associate these communications in a data object representing a conversation. The normalized data can be used in combination with the natural language processing described herein to surface search results for the data archive.

At step 615, the process 600 includes generating one or more vectors based on the plurality of second data items. Step 615 can be performed similar to step 309 of the process 300 (FIG. 3), step 406 of the process 400 (FIG. 4), or step 506 of the process 500 (FIG. 5).

At step 618, the process 600 includes determining similarity between the cluster of step 606 and the one or more vectors generated at step 615. According to one embodiment, vectors that demonstrate a threshold-satisfying similarity to a cluster may be referred to as vectors that match, or are matched to, the cluster. Step 618 can be performed similar to steps 312-315 of the process 300 (FIG. 3) or step 409 of the process 400 (FIG. 4).

At step 621, the process 600 includes identifying one or more of the plurality of second data items to surface based on whether the similarity scores meet the threshold at step 618. The communication service 204 can retrieve the identified data items from the archive or data store. The communication service 204 can retrieve metadata describing the identified data items for presentation to a user.

At step 624, the process 600 includes performing one or more appropriate actions, such as, for example, any action of the actions discussed in relation to step 324 of the process 300 (FIG. 3), step 412 of the process 400 (FIG. 4) or step 518 of the process 500 (FIG. 5). The communication service 204 can cause a user interface to be rendered including the search results and/or metadata describing the search results. The communication service 204 can surface the identified data items to one or more users. In some embodiments, the communication service 204 can store an association for the identified data items for later processing or review.

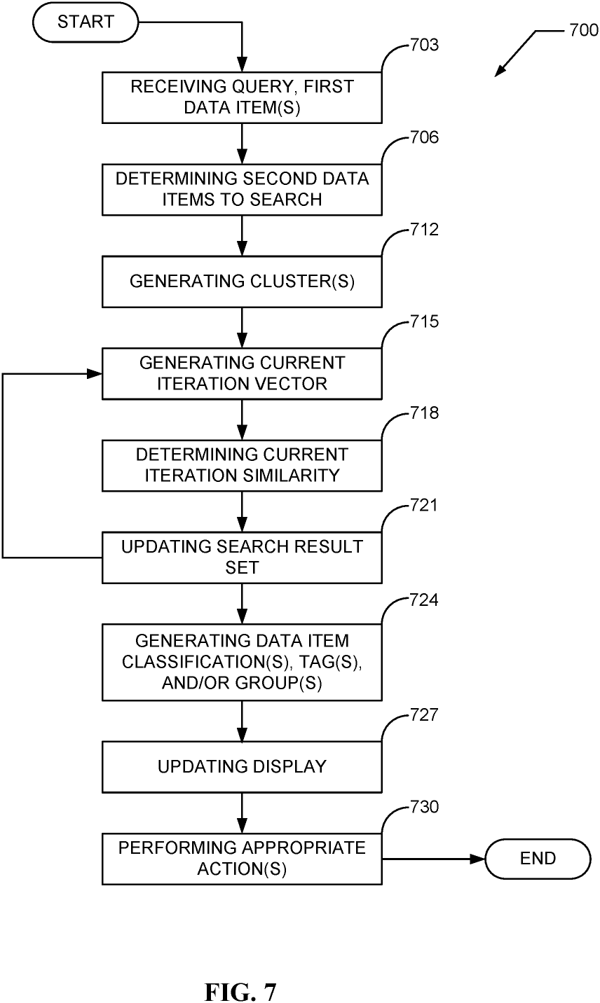

FIG. 7 shows an exemplary discovery process 700 according to one embodiment of the present disclosure. In some embodiments, the process 700 can be used to surface results for a pending litigation, such as during electronic discovery (eDiscovery) during litigation.

At step 703, the process 700 includes receiving a query with one or more first data items. The query can include a search strong, a search term, a document, a communication, or other data item. In some embodiments, the query can include one or more other data items in the data set to be searched. As an example, the user can find one or more particular data items they are looking for, and search using those particular data items in a query to identify other similar data items in a document set. The communication service 204 can receive the search request via a user interface, such as an eDiscovery system or through some other method as can be appreciated. In some embodiments, the communication service 204 can load a set of predefined queries that each include data items to be searched.

At step 706, the process 700 includes determining a plurality of second data items to be searched. In some embodiments, the communication service 204 can load a data set for processing during an eDiscovery. In some embodiments, the communication service 204 can receive one or more filters to limit the data set for the search. For example, the communication service 204 can receive a filter parameter to only surface results within a particular data range, corresponding to a particular communication modality or set of communication modalities, from or to a particular user account, or some other filter parameter.

In various embodiments, the process 700 includes performing steps 715-724 (e.g., or a subset thereof) in an iterative manner such that each of the plurality of second items are individually compared to a cluster derived from the first data item and, in some embodiments, clusters derived from one or more third data items with which a one of the plurality of predefined queries is associated.

At step 712, the process 700 includes generating a cluster based on the one or more first data items. In some embodiments, at step 712, the process 700 includes iteratively generating clusters for multiple search queries and iterating through the process 700 for each search query. In some embodiments, the process 700 includes generating a respective cluster for each of a set of search queries and performing the iterative steps from 715-724 for each cluster during each iteration through the second data items to be searched. Step 712 can be performed similar to step 303 of the process 300 (FIG. 3), step 415 of the process 400 (FIG. 4), or steps 506-509 of the process 500 (FIG. 5).

At step 715, the process 700 includes iteratively generating a vector based on data items to be searched against (e.g., a current iteration second data item). The communication service 204 can iterative through each data item to be searched and generate the current iteration vector. Step 715 can be performed similar to step 309 of the process 300 (FIG. 3), step 406 of the process 400 (FIG. 4), or step 506 of the process 500 (FIG. 5).

At step 718, the process 700 includes determining similarity between the current iteration second data item-derived vector and the query-derived cluster. Step 718 can be performed similar to steps 312-315 of the process 300 (FIG. 3) or step 409 of the process 400 (FIG. 4).

At step 721, the process 700 includes updating a search result set in response to determining that the current iteration second data item demonstrates a threshold-satisfying similarity to the first data item-derived cluster and/or a current iteration third data item-derived cluster. In some embodiments, the process 700 can include updating multiple search result sets when a respective iteration data item meets a respective threshold. As an example, a current iteration data item may have a threshold satisfying similarity to two of four clusters corresponding to two of four predefined search queries. The current iteration data item can be added to two of the four search result sets, but not to the other two search result sets for which the current iteration data item did not satisfy the threshold similarity.

At step 724, the process 700 includes generating a classification, tagging, and/or grouping data items in a search result set. In one embodiment, the process 700 can include tagging the data items in the search result set with a tag corresponding to a searched data item from step 703. For example, a correspondence tagged as “attorney’s eyes only” can be query to find similar correspondences using process 700, and the search results from that query can also be tagged as “attorney’s eyes only.” As another example, a user can specify that the query related to a financial reporting issue, and the search results can be classified as relating to the financial reporting issue.

At step 727, the process 700 includes updating a display. The process 700 can include rendering the search results for a user to review. In some embodiments, the user interface can include suggested edits to metadata for each data item based on the data item being surfaced in the search results. As an example, the system can analyze the search results to determine that a subset of the documents all have a similar classification or tag, and suggest classifying or tagging the other data items with those same values.

At step 730, the process 700 includes performing one or more appropriate actions, such as, for example, any action of the actions discussed in relation to step 324 of the process 300 (FIG. 3), step 412 of the process 400 (FIG. 4) or step 518 of the process 500 (FIG. 5).

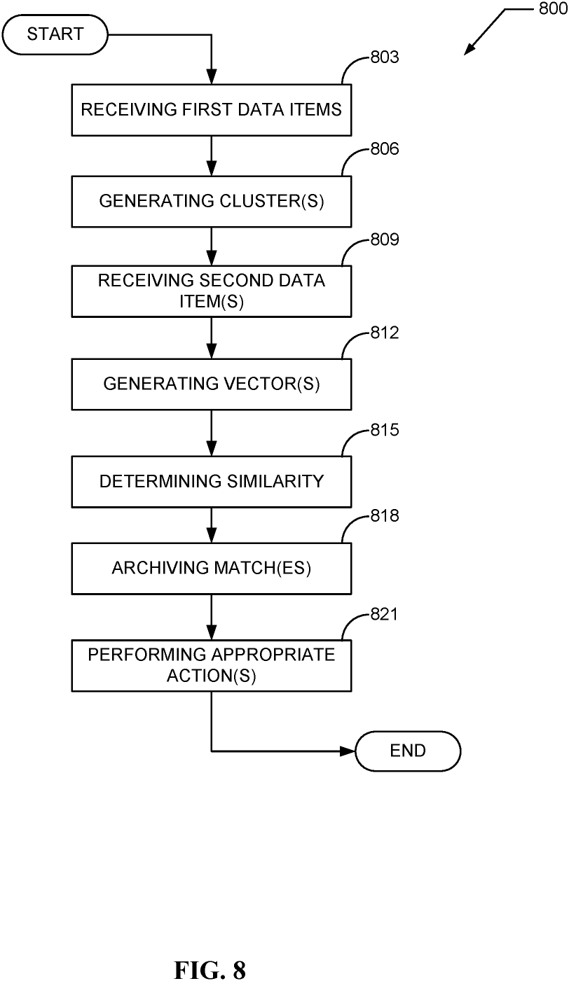

FIG. 8 shows an exemplary archiving process 800 according to one embodiment of the present disclosure. In some embodiments, the process 800 can be used to determine a retention policy for one or more data items. In other embodiments, the process 800 can be used to determine whether to archive an event or data item.

At step 803, the process 800 includes receiving a plurality of first data items. In some embodiments, the communication service 204 can receive one or more policies defining the first data items. As an example, the policy can define that communications that relate to company trade secrets are archived using a first retention policy, that communications related to finance are archived using a second retention policy, and that all other communications are archived using a default retention policy. The first data items may correspond to exemplary data items for which a data retention policy is to be applied. For example, the first data items may include a set of historical or fabricated correspondences that share company trade secrets with third parties.

At step 806, the process 800 includes generating one or more clusters based on the plurality of first data items. Step 806 can be performed similar to step 303 of the process 300 (FIG. 3), step 415 of the process 400 (FIG. 4), or steps 506-509 of the process 500 (FIG. 5).

At step 809, the process 800 includes receiving one or more second data items. The communication service 204 can receive communications or data items as they are sent/generated. Once received, the communication service 204 can perform steps 812-821 to, for example, find which retention policy to apply to the particular data item received. In some embodiments, the communication service 204 can queue data items as each data item is received for processing. The communication service 204 can wait until a set number of data items have been queued or work through the queue to process data items in the queue without waiting.

At step 812, the process 800 includes generating one or more vectors based on the one or more second data items. The communication service 204 can generate a single vector for each data item as the data item is received in step 809 to determine the retention policy for that data item. Step 812 can be performed similar to step 309 of the process 300 (FIG. 3), step 406 of the process 400 (FIG. 4), or step 506 of the process 500 (FIG. 5).

At step 815, the process 800 includes determining similarity between each of the one or more vectors of step 812 and the one or more clusters of step 806. Step 815 can be performed similar to steps 312-315 of the process 300 (FIG. 3) or step 409 of the process 400 (FIG. 4).

At step 818, the process 800 includes archiving, at a data archive, one or more second data items whose corresponding vectors demonstrated a threshold-satisfying similarity, or were otherwise matched to, the one or more vectors of step 806 using a particular retention policy corresponding to the cluster that was matched. In some embodiments, the process 800 can include archiving, at the data archive, one or more second data items whose corresponding vector did not meet any cluster thresholds using a default data retention policy. The data store 211 can include one or more data archives at which the one or more cluster-matching second data items are stored. The communication service 204 can transmit the one or more cluster-matching second data items to an additional storage environment for archiving, such as, for example, a cloud-based data archive. The communication service 204 can cause the computing device 203 from which the one or more second data items were received (e.g., or another computing device 203 associated therewith) to store the one or more cluster-matching second data items at a particular storage environment (e.g., a local database, remote database, or other memory). In some embodiments, a retention policy can be a default retention policy that is implemented, for example, in response to a data item demonstrating little to no similarity to one or more clusters. In some embodiments, the communication service 204 can determine that a data item meets the threshold to match multiple clusters. The communication service 204 can apply one or more rules to compare or analyze the retention policies to determine an appropriate retention policy for the data item. As an example, the communication service 204 can determine a longest or strictest retention policy of the identified retention policies, and apply the longest retention policy to the data item.

At step 821, the process 800 includes performing one or more appropriate actions, such as, for example, any action of the actions discussed in relation to step 324 of the process 300 (FIG. 3), step 412 of the process 400 (FIG. 4) or step 518 of the process 500 (FIG. 5).

In some embodiments, the rules service 209 applies one or more rules 216 for defining subsets of the plurality of second data items based on the corresponding similarity between one or more second data items and the one or more clusters of step 906. For example, the rules service 209 a) generates a first subset of second data items that includes second data items with similarity scores falling within a first range, b) generates a second subset of second data items that includes second data items with similarity scores falling within a second range (e.g., greater than and excluding the first range), and c) generates a third subset of second data items that includes second data items with similarity scores falling within a third range (e.g., greater than and excluding the first and second ranges).

At step 918, the process 900 includes determining a retention policy for each subset of the plurality of second data items based on the respective similarity score (e.g., or other determination of similarity between the respective second data item and the one or more clusters of step 906). The rules service 209 can determine the retention policy by applying one or more rules 216 to the each respective subset of second data items.

At step 921, the process includes storing each subset of the plurality of second data items based on the respective retention policy. For example, based on a first retention policy the communication service 204 stores a first subset at a secure data archive for a minimum storage period of 10 years. In the same example, based on a second retention policy the communication service 204 stores a second subset at the secure data archive for a minimum storage period of 3 years. Continuing the example, based on a third retention policy the communication service 204 stores a third subset at in local storage of a computing device 203 (e.g., with continue storage being at the 0discretion of a user of the computing device 203).

At step 924, the process 900 includes performing one or more appropriate actions, such as, for example, any action of the actions discussed in relation to step 324 of the process 300 (FIG. 3), step 412 of the process 400 (FIG. 4) or step 518 of the process 500 (FIG. 5).

From the foregoing, it will be understood that various aspects of the processes described herein are software processes that execute on computer systems that form parts of the system. Accordingly, it will be understood that various embodiments of the system described herein are generally implemented as specially-configured computers including various computer hardware components and, in many cases, significant additional features as compared to conventional or known computers, processes, or the like, as discussed in greater detail herein. Embodiments within the scope of the present disclosure also include computer-readable media for carrying or having computer-executable instructions or data structures stored thereon. Such computer-readable media can be any available media which can be accessed by a computer, or downloadable through communication networks. By way of example, and not limitation, such computer-readable media can comprise various forms of data storage devices or media such as RAM, ROM, flash memory, EEPROM, CD-ROM, DVD, or other optical disk storage, magnetic disk storage, solid state drives (SSDs) or other data storage devices, any type of removable non-volatile memories such as secure digital (SD), flash memory, memory stick, etc., or any other medium which can be used to carry or store computer program code in the form of computer-executable instructions or data structures and which can be accessed by a general purpose computer, special purpose computer, specially-configured computer, mobile device, etc.

When information is transferred or provided over a network or another communications connection (either hardwired, wireless, or a combination of hardwired or wireless) to a computer, the computer properly views the connection as a computer-readable medium. Thus, any such connection is properly termed and considered a computer-readable medium. Combinations of the above should also be included within the scope of computer-readable media. Computer-executable instructions comprise, for example, instructions and data which cause a general purpose computer, special purpose computer, or special purpose processing device such as a mobile device processor to perform one specific function or a group of functions.

Those skilled in the art will understand the features and aspects of a suitable computing environment in which aspects of the disclosure may be implemented. Although not required, some of the embodiments of the claimed systems may be described in the context of computer-executable instructions, such as program modules or engines, as described earlier, being executed by computers in networked environments. Such program modules are often reflected and illustrated by flow charts, sequence diagrams, exemplary screen displays, and other techniques used by those skilled in the art to communicate how to make and use such computer program modules. Generally, program modules include routines, programs, functions, objects, components, data structures, application programming interface (API) calls to other computers whether local or remote, etc. that perform particular tasks or implement particular defined data types, within the computer. Computer-executable instructions, associated data structures and/or schemas, and program modules represent examples of the program code for executing steps of the methods disclosed herein. The particular sequence of such executable instructions or associated data structures represent examples of corresponding acts for implementing the functions described in such steps.

Those skilled in the art will also appreciate that the claimed and/or described systems and methods may be practiced in network computing environments with many types of computer system configurations, including personal computers, smartphones, tablets, hand-held devices, multi-processor systems, microprocessor-based or programmable consumer electronics, networked PCs, minicomputers, mainframe computers, and the like. Embodiments of the claimed system are practiced in distributed computing environments where tasks are performed by local and remote processing devices that are linked (either by hardwired links, wireless links, or by a combination of hardwired or wireless links) through a communications network. In a distributed computing environment, program modules may be located in both local and remote memory storage devices.

An exemplary system for implementing various aspects of the described operations, which is not illustrated, includes a computing device including a processing unit, a system memory, and a system bus that couples various system components including the system memory to the processing unit. The computer will typically include one or more data storage devices for reading data from and writing data to. The data storage devices provide nonvolatile storage of computer-executable instructions, data structures, program modules, and other data for the computer.

Computer program code that implements the functionality described herein typically comprises one or more program modules that may be stored on a data storage device. This program code, as is known to those skilled in the art, usually includes an operating system, one or more application programs, other program modules, and program data. A user may enter commands and information into the computer through keyboard, touch screen, pointing device, a script containing computer program code written in a scripting language or other input devices (not shown), such as a microphone, etc. These and other input devices are often connected to the processing unit through known electrical, optical, or wireless connections.

The computer that effects many aspects of the described processes will typically operate in a networked environment using logical connections to one or more remote computers or data sources, which are described further below. Remote computers may be another personal computer, a server, a router, a network PC, a peer device or other common network node, and typically include many or all of the elements described above relative to the main computer system in which the systems are embodied. The logical connections between computers include a local area network (LAN), a wide area network (WAN), virtual networks (WAN or LAN), and wireless LANs (WLAN) that are presented here by way of example and not limitation. Such networking environments are commonplace in office-wide or enterprise-wide computer networks, intranets, and the Internet.

When used in a LAN or WLAN networking environment, a computer system implementing aspects of the system is connected to the local network through a network interface or adapter. When used in a WAN or WLAN networking environment, the computer may include a modem, a wireless link, or other mechanisms for establishing communications over the wide area network, such as the Internet. In a networked environment, program modules depicted relative to the computer, or portions thereof, may be stored in a remote data storage device. It will be appreciated that the network connections described or shown are exemplary and other mechanisms of establishing communications over wide area networks or the Internet may be used.

While various aspects have been described in the context of a preferred embodiment, additional aspects, features, and methodologies of the claimed systems will be readily discernible from the description herein, by those of ordinary skill in the art. Many embodiments and adaptations of the disclosure and claimed systems other than those herein described, as well as many variations, modifications, and equivalent arrangements and methodologies, will be apparent from or reasonably suggested by the disclosure and the foregoing description thereof, without departing from the substance or scope of the claims. Furthermore, any sequence(s) and/or temporal order of steps of various processes described and claimed herein are those considered to be the best mode contemplated for carrying out the claimed systems. It should also be understood that, although steps of various processes may be shown and described as being in a preferred sequence or temporal order, the steps of any such processes are not limited to being carried out in any particular sequence or order, absent a specific indication of such to achieve a particular intended result. In most cases, the steps of such processes may be carried out in a variety of different sequences and orders, while still falling within the scope of the claimed systems. In addition, some steps may be carried out simultaneously, contemporaneously, or in synchronization with other steps.

Aspects, features, and benefits of the claimed devices and methods for using the same will become apparent from the information disclosed in the exhibits and the other applications as incorporated by reference. Variations and modifications to the disclosed systems and methods may be effected without departing from the spirit and scope of the novel concepts of the disclosure.

It will, nevertheless, be understood that no limitation of the scope of the disclosure is intended by the information disclosed in the exhibits or the applications incorporated by reference; any alterations and further modifications of the described or illustrated embodiments, and any further applications of the principles of the disclosure as illustrated therein are contemplated as would normally occur to one skilled in the art to which the disclosure relates.

The foregoing description of the exemplary embodiments has been presented only for the purposes of illustration and description and is not intended to be exhaustive or to limit the devices and methods for using the same to the precise forms disclosed. Many modifications and variations are possible in light of the above teaching.

The embodiments were chosen and described in order to explain the principles of the devices and methods for using the same and their practical application so as to enable others skilled in the art to utilize the devices and methods for using the same and various embodiments and with various modifications as are suited to the particular use contemplated. Alternative embodiments will become apparent to those skilled in the art to which the present devices and methods for using the same pertain without departing from their spirit and scope. Accordingly, the scope of the present devices and methods for using the same is defined by the appended claims rather than the foregoing description and the exemplary embodiments described therein.

What is claimed is:

1. A natural language process, comprising:
receiving, via at least one computing device, a plurality of first data items;
generating, via the at least one computing device, a cluster based on the plurality of first data items;
intercepting, via the at least one computing device, a plurality of second data items communicated between a first computing device and at least one second computing device;
generating, via the at least one computing device, at least one vector based on the plurality of second data items;
determining, via the at least one computing device, a similarity score between the at least one vector and the cluster; and
in response to the similarity score meeting a predefined threshold, identifying, via the at least one computing device, at least one of the plurality of second data items for review.

2. The natural language process of claim 1, wherein intercepting the plurality of second data items comprises intercepting communication data at a network appliance.

3. The natural language process of claim 1, further comprising:
retrieving, via the at least one computing device, at least one rule associated with the cluster; and
applying, via the at least one computing device, the at least one rule to determine whether the similarity score meets the predefined threshold.

4. The natural language process of claim 1, wherein determining the similarity score comprises determining a distance between the at least one vector and the cluster.

5. The natural language process of claim 4, wherein the distance comprises a plurality of dimensions.

6. The natural language process of claim 1, wherein the plurality of first data items comprises a plurality of historical communications associated with at least one rule violation.

7. The natural language process of claim 1, wherein generating the cluster comprises:
generating, via the at least one computing device, a plurality of vectors individually associated with the plurality of first data items; and
defining, via the at least one computing device, a shape comprising the plurality of vectors.

8. The natural language process of claim 1, wherein generating the cluster comprises:
generating, via the at least one computing device, a plurality of vectors individually associated with the plurality of first data items;
computing a centroid of the plurality of vectors; and
defining the cluster based on a predetermined distance from the centroid.

9. A system, comprising:
a memory; and
at least one computing device in communication with the memory, the at least one computing device being configured to:
receive a plurality of first data items;
generate a cluster based on the plurality of first data items;
intercept a plurality of second data items communicated between a first computing device and at least one second computing device;
generate at least one vector based on the plurality of second data items;
determine a similarity score between the at least one vector and the cluster; and
identify at least one of the plurality of second data items for review based at least in part on the similarity score.

10. The system of claim 9, wherein the at least one computing device is further configured to:
generate a plurality of vectors individually corresponding to the plurality of first data items; and
generate the cluster based on the plurality of vectors.

11. The system of claim 9, wherein the at least one computing device is further configured to cause a user interface to be rendered on a display, the user interface comprising a cluster visualization of the cluster.

12. The system of claim 11, wherein the at least one computing device is further configured to:
receive an input via the user interface to adjust the size of the cluster;
determine an updated similarity score between the at least one vector and the adjusted cluster; and
identify at least one different one of the plurality of second data items for review based at least in part on the updated similarity score.

13. The system of claim 9, wherein the plurality of first data items comprises a plurality of textual strings.

14. The system of claim 9, wherein the plurality of second data items comprises data from at least one of: a text message, an email, an instant message, and a phone call sent from the first computing device to at least one second computing device.

15. A non-transitory computer-readable medium embodying a program that, when executed by at least one computing device, causes the at least one computing device to:
receive a plurality of first data items;
generate a cluster based on the plurality of first data items;
intercept a plurality of second data items communicated between a first computing device and at least one second computing device;
generate a plurality of vectors individually corresponding to the plurality of second data items;
determine a plurality of similarity scores between each of the plurality of vectors and the cluster; and
identify at least one of the plurality of second data items for review by applying at least one rule based on the plurality of similarity scores.

16. The non-transitory computer-readable medium of claim 15, wherein the program further causes the at least one computing device to:
determine a first language corresponding to a first one of the plurality of second data items;
determine a second language corresponding to a second one of the plurality of second data items;
generate a first vector corresponding to the first one of the plurality of second data items using a first algorithm corresponding to the first language; and
generate a second vector corresponding to the second one of the plurality of second data items using a second algorithm corresponding to the second language, wherein the plurality of vectors comprise the first vector and the second vector.

17. The non-transitory computer-readable medium of claim 15, wherein the at least one rule comprises at least one first rule when the first computing device is within a geofence when the plurality of second data items were communicated and at least one second rule differing from the at least one first rule when the first computing device is outside of the geofence when the plurality of second data items were communicated.

18. The non-transitory computer-readable medium of claim 15, wherein the program further causes the at least one computing device to:
receive a plurality of third data items;
tuning the cluster based on the plurality of third data items to generate an updated cluster;
determine an updated similarity score between the plurality of vectors and the updated cluster; and
identify at least one different ones of the plurality of second data items for review by applying the at least one rule based on the updated similarity score.

19. The non-transitory computer-readable medium of claim 15, wherein the program further causes the at least one computing device to:
capture an audio file corresponding to a phone call between the first computing device and the at least one second computing device; and
analyze the audio file using a speech to text algorithm to generate a textual string, wherein the plurality of second data items comprises the textual string.

20. The non-transitory computer-readable medium of claim 15, wherein the program further causes the at least one computing device to identify a plurality of additional data items for review based on a similarity to the at least one of the plurality of second data items identified for review.
